(19) United States
(12) Patent Application Publication
(10) Pub. No.: US 2026/0105720 A1
(43) Pub. Date: Apr. 16, 2026

(54) CORRESPONDENCE POINT MATCHING METHOD AND SYSTEM

(71) Applicant: Medipixel, Inc., Seoul (KR)

(72) Inventors: Hyunwoo Kim, Seoul (KR); Sooncheol Noh, Seoul (KR); Eunjin Jung, Seoul (KR); Si-Hyuck Kang, Seoul (KR); Sun-Hwa Kim, Yongin-si (KR)

(21) Appl. No.: 19/235,330

(22) Filed: Jun. 11, 2025

Related U.S. Application Data
(63) Continuation of application No. PCT/KR2024/002243, filed on Feb. 21, 2024.

(30) Foreign Application Priority Data
Feb. 21, 2023 (KR) 10-2023-0023225
Feb. 21, 2023 (KR) 10-2023-0023226
Oct. 23, 2023 (KR) 10-2023-0142440

(51) Int. Cl. G06V 10/75; G06V 10/74; G06V 10/774; G06V 10/82

(52) U.S. Cl. CPC G06V 10/751; G06V 10/761; G06V 10/774; G06V 10/82; G06V 2201/03; G06V 2201/10

(57) ABSTRACT

A correspondence point matching method performed by at least one processor, includes obtaining a first training patch image and a second training patch image associated with the first training patch image, and training a machine learning model, based on the obtained first and second training patch images, so that a first feature point associated with the first training patch image corresponds to a second feature point associated with the second training patch image, wherein the machine learning model is trained to determine, as an allowable movement range for a feature point, a second range different from a first range associated with at least one of the first training patch image or the second training patch image, and move at least one of the first feature point or the second feature point to a target point within the determined second range.

### CROSS-REFERENCE TO RELATED APPLICATION(S)

The present application is a continuation of International Patent Application No. PCT/KR2024/002243, filed on Feb. 21, 2024, which claims priority to and the benefit of Korean Patent Application No. 10-2023-0023225, filed on Feb. 21, 2023, Korean Patent Application No. 10-2023-0023226, filed on Feb. 21, 2023, and Korean Patent Application No. 10-2023-0142440, filed on Oct. 23, 2023, in the Korean Intellectual Property Office, the entire disclosures of which are incorporated herein by reference.

### BACKGROUND

### Field

The present disclosure relates to a correspondence point matching method and system.

### Description of the Related Art

Recently, in medical practice, there is an increasing tendency to reconstruct two-dimensional images obtained using X-ray imaging, CT imaging, cardiovascular angiography, and the like into three-dimensional images, thereby visualizing them in an intuitive manner for lesion diagnosis or image interpretation. In such three-dimensional reconstruction of medical images, it is essential to match characteristic points (for example, Common Image Points, CIPs) by correspondence to compensate for mechanical errors of imaging device, and the quality of the reconstructed three-dimensional image may vary depending on the matching accuracy of the correspondence points.

A machine learning model is used to select such characteristic points. However, compared with a method of training a machine learning model on general images, a method of training a machine learning model on medical images may incur high cost and time. For example, because the task of labeling target points by analyzing medical images containing cardiovascular structures is performed by medical experts, considerable cost and time may be required. That is, it is not only difficult to collect medical images for training, but the labeling task also requires substantial cost and time.

Accordingly, there is a demand for technology capable of accurately matching characteristic points contained in medical images at low cost.

### SUMMARY

The present disclosure provides a correspondence point matching method, a computer-readable recording medium storing a computer program, a computer-readable recording medium, and a device (system) for solving the above-described problems.

The present disclosure can be implemented in various forms including a method, a device (system), and/or a computer-readable recording medium storing a computer program.

In some embodiments, a correspondence point matching method performed by at least one processor, may include obtaining a first training patch image and a second training patch image associated with the first training patch image, and training a machine learning model, based on the obtained first and second training patch images, so that a first feature point associated with the first training patch image corresponds to a second feature point associated with the second training patch image, and the machine learning model is trained to determine, as an allowable movement range for a feature point, a second range different from a first range associated with at least one of the first training patch image or the second training patch image, and is trained to move at least one of the first feature point or the second feature point to a target point within the determined second range.

In some embodiments, the second range is wider than the first range and is determined based on an area occupied by the first training patch image in a medical image.

In some embodiments, obtaining the second training patch image may include obtaining, from a medical image, the second training patch image having a size associated with the second range, and the second training patch image having the size associated with the second range and the first training patch image are input to the machine learning model.

In some embodiments, the machine learning model is trained to move a first feature point initially determined from the first training patch image to a first target point and to move a second feature point initially determined from the second training patch image to a second target point.

In some embodiments, the initially determined first feature point is a center of the first training patch image and the initially determined second feature point is a center of the second training patch image.

In some embodiments, training the machine learning model may include inputting the first and second training patch images to the machine learning model and training the machine learning model so that the second feature point is moved to a second target point, and inputting the second training patch image, in which the second feature point has been moved, and the first training patch image to the machine learning model and training the machine learning model so that the first feature point is moved to a first target point.

In some embodiments, if the machine learning model determines that the target point is located within the second range, the machine learning model is trained to associate the first feature point with the second feature point.

In some embodiments, the correspondence point matching method, may further include receiving a plurality of images in which a cardiovascular structure is captured, obtaining vascular information associated with each of the plurality of images, generating, based on the vascular information, a plurality of feature vectors corresponding respectively to the plurality of images, and using the machine learning model to associate at least one point of each of the plurality of images with a corresponding point of another one of the plurality of images, based on the plurality of feature vectors, and each of the plurality of images is different from each other.

In some embodiments, obtaining the vascular information may include identifying a first image and a second image among the plurality of images, obtaining first center-line information corresponding to a center-line of at least a portion of blood vessels included in the first image, and obtaining second center-line information corresponding to a center-line of at least a portion of blood vessels included in the second image, and generating the plurality of feature vectors may include generating a first set of patch images based on the first center-line information, and generating a second set of patch images based on the second center-line information.

In some embodiments, generating the plurality of feature vectors may include generating a first set of positional embedding vectors corresponding respectively to the first set of patch images, generating a second set of positional embedding vectors corresponding respectively to the second set of patch images, generating a first feature vector, using a transformer model, based on the first set of positional embedding vectors, and generating a second feature vector, using the transformer model, based on the second set of positional embedding vectors.

In some embodiments, using the machine learning model to associate the at least one point of each of the plurality of images with the corresponding point of another one of the plurality of images may include generating a score matrix by determining correlation coefficients among the plurality of feature vectors, and determining, based on the generated score matrix, at least one point in each of the plurality of images as a correspondence point.

In some embodiments, training the machine learning model may include receiving camera meta information associated with the first and second training patch images, and inputting the camera meta information to the machine learning model.

In some embodiments, a correspondence point matching method performed by at least one processor, may include obtaining a first training patch image and a second training patch image associated with the first training patch image, and training a machine learning model, based on the obtained first and second training patch images, so that a first feature point associated with the first training patch image corresponds to a second feature point associated with the second training patch image, and the machine learning model is trained to move the first feature point to a first target point and to move the second feature point to a second target point.

In some embodiments, the machine learning model is trained to determine, as a movable range for a feature point, a second range wider than a first range associated with at least one of the first training patch image or the second training patch image, and to move the first feature point to the first target point within the second range.

In some embodiments, a non-transitory computer-readable recording medium storing a computer program for executing at least one of the above-mentioned methods on a computer.

In some embodiments, an information processing system may include a memory, and at least one processor connected to the memory and configured to execute at least one computer-readable program stored in the memory, wherein the at least one program includes instructions to obtain a first training patch image and a second training patch image associated with the first training patch image, and train a machine learning model, based on the obtained first and second training patch images, so that a first feature point associated with the first training patch image corresponds to a second feature point associated with the second training patch image, and the machine learning model is trained to determine, as an allowable movement range for a feature point, a second range different from a first range associated with at least one of the first training patch image or the second training patch image, and move at least one of the first feature point or the second feature point to a target point within the second range.

In some embodiments, an information processing system may include a memory, and at least one processor connected to the memory and configured to execute at least one computer-readable program stored in the memory, wherein the at least one program includes instructions to obtain a first training patch image and a second training patch image associated with the first training patch image, and train a machine learning model, based on the obtained first and second training patch images, so that a first feature point associated with the first training patch image corresponds to a second feature point associated with the second training patch image, and the machine learning model is trained to move the first feature point to a first target point and to move the second feature point to a second target point.

According to some embodiments of the present disclosure, because the machine learning model is configured to perform second matching (point matching) based on a second range wider than a first range associated with a patch image, accuracy of the machine learning model for the second matching may be improved.

According to some embodiments of the present disclosure, even if a target point is not present within a patch image, the target point is searched in the enlarged second range, thereby reducing the failure rate of the second matching and increasing the amount of training data used for second matching training.

According to some embodiments of the present disclosure, because the machine learning model is configured so that both a first feature point associated with a first patch image and a second feature point associated with a second patch image can be moved, even when a patch image whose center is not set as a target point is input to the machine learning model, a specific point can be placed at the correct location by moving the point.

The effects of the present disclosure are not limited to the effects mentioned above, and other effects not mentioned can be clearly understood by those skilled in the art from the description of the claims.

### BRIEF DESCRIPTION OF THE DRAWINGS

Embodiments of the present disclosure will be described below with reference to the accompanying drawings, in which like reference numerals denote like elements, but the present disclosure is not limited thereto.

FIG. 1 illustrates an example of a method by which an information processing system according to an embodiment of the present disclosure acquires matching data based on a plurality of medical images.

FIG. 2 is a block diagram illustrating an information processing system that provides a correspondence point automatic matching service for three-dimensional reconstruction of medical images according to an embodiment of the present disclosure.

FIG. 3 is an exemplary diagram for explaining first matching and second matching.

FIG. 4 illustrates a method of training a first matching module and a second matching module according to an embodiment of the present disclosure.

FIG. 5 is an exemplary diagram illustrating a neural network model according to an embodiment of the present disclosure.

FIG. 6 is an exemplary diagram for explaining an enlarged second range according to an embodiment of the present disclosure.

FIG. 7 illustrates various examples in which initially determined feature points are moved according to an embodiment of the present disclosure.

FIG. 8 is an exemplary diagram for explaining a method in which a plurality of feature points are moved according to an embodiment of the present disclosure.

FIG. 9 is an exemplary diagram for explaining a method of training a second matching module according to an embodiment of the present disclosure.

FIG. 10 is a flowchart for explaining a learning method for matching correspondence points according to an embodiment of the present disclosure.

FIG. 11 is a flowchart for explaining a method of matching correspondence points using a machine learning model according to an embodiment of the present disclosure.

FIG. 12 illustrates an example of a method by which a computing device according to an embodiment of the present disclosure acquires a CIP set based on a plurality of images capturing the cardiovascular structure.

FIG. 13 is a block diagram illustrating a computing device that provides a CIP automatic detection service for three-dimensional reconstruction of cardiovascular images according to an embodiment of the present disclosure.

FIG. 14 illustrates a flowchart of a CIP automatic matching method according to an embodiment of the present disclosure.

FIG. 15 illustrates an example of a method of acquiring a CIP set based on a first image and a second image capturing the cardiovascular structure according to an embodiment of the present disclosure.

FIG. 16 illustrates a specific method of generating a plurality of feature vectors based on a plurality of images capturing the cardiovascular structure according to an embodiment of the present disclosure.

FIG. 17 illustrates an example in which center-line information corresponding to a center line of part of a vessel included in an image capturing the cardiovascular structure is extracted according to an embodiment of the present disclosure.

FIG. 18 illustrates an example in which a plurality of patch images of a center line of part of a vessel included in an image capturing the cardiovascular structure are generated according to an embodiment of the present disclosure.

FIG. 19 illustrates an example of a method of determining a CIP set using a first feature vector for a first image and a second feature vector for a second image capturing the cardiovascular structure according to an embodiment of the present disclosure.

FIG. 20 is an exemplary diagram illustrating a neural network model according to an embodiment of the present disclosure.

FIG. 21 illustrates an example of a method by which a computing device acquires characteristic candidate point matching data based on a plurality of images capturing the cardiovascular structure according to an embodiment of the present disclosure.

FIG. 22 is a block diagram illustrating a computing device that provides a CIP automatic detection service for three-dimensional reconstruction of cardiovascular images according to an embodiment of the present disclosure.

FIG. 23 illustrates a flowchart of a CIP automatic matching method according to an embodiment of the present disclosure.

FIG. 24 illustrates an example of a method of performing CIP matching based on a first image and a second image capturing the cardiovascular structure according to an embodiment of the present disclosure.

FIG. 25 illustrates an example of a plurality of characteristic candidate points extracted based on an image capturing the cardiovascular structure according to an embodiment of the present disclosure.

FIG. 26 is a diagram for explaining a method of acquiring a plurality of visual descriptors using a plurality of characteristic candidate points in an image capturing the cardiovascular structure according to an embodiment of the present disclosure.

FIG. 27 illustrates an example of performing characteristic point matching between a first image and a second image capturing a specific cardiovascular structure according to an embodiment of the present disclosure.

FIG. 28 is a diagram for explaining a learning method of a visual feature detection model according to an embodiment of the present disclosure.

FIG. 29 is a diagram for explaining a learning method of a visual descriptor generation model according to an embodiment of the present disclosure.

FIG. 30 is a diagram for explaining a learning method of a characteristic point matching model according to an embodiment of the present disclosure.

FIG. 31 is a diagram for explaining a method of performing characteristic point matching between images capturing a specific cardiovascular structure according to another embodiment of the present disclosure.

### DETAILED DESCRIPTION

Hereinafter, specific details for carrying out the present disclosure will be described in detail with reference to the accompanying drawings. However, in the following description, detailed descriptions of well-known functions or configurations that may obscure the gist of the present disclosure will be omitted.

In the accompanying drawings, identical or corresponding components are denoted by the same reference numerals. In addition, in the descriptions of the embodiments below, redundant descriptions of identical or corresponding components may be omitted. However, even if a description of a component is omitted, it is not intended that such a component is excluded from an embodiment.

Advantages and characteristics of the disclosed embodiments, and methods for achieving them, will become apparent with reference to the embodiments described below in conjunction with the accompanying drawings. However, the present disclosure is not limited to the embodiments disclosed below but may be embodied in various different forms, and the embodiments are provided merely to make the present disclosure complete and to fully convey the scope of the disclosure to those of ordinary skill in the art.

Terms used in the present specification will be briefly explained, and the disclosed embodiments will be described in detail. The terms used in the present specification have been selected as commonly used terms as much as possible in consideration of the functions in the present disclosure, but the meanings may vary depending on the intention of a skilled person, judicial precedents, the emergence of new technology, and the like. In certain cases, there are terms arbitrarily selected by the applicant, in which case the meanings will be described in detail in the corresponding description of the invention. Therefore, the terms used in the present disclosure should be defined based on the meanings of the terms and the overall content of the present disclosure rather than on the simple names of the terms.

Unless explicitly stated otherwise in context, the singular expressions used in the present specification also include plural expressions. Likewise, unless explicitly stated otherwise in context, plural expressions include singular expressions. Throughout the specification, when a portion “includes” a component, unless there is a particular statement to the contrary, this does not exclude the presence of other components but means that other components may be further included.

In addition, the terms “module” and “unit” used in the specification mean software or hardware components and perform certain roles. However, “module” or “unit” is not limited to software or hardware. A module or unit may be configured to reside in an addressable recording medium and may be configured to reproduce one or more processors. Therefore, as an example, a module or unit may include at least one of software components, object-oriented software components, class components, and task components, processes, functions, attributes, procedures, subroutines, program code segments, drivers, firmware, micro-code, circuits, data, databases, data structures, tables, arrays, or variables. Functions provided inside components and modules or units may be combined into a smaller number of components, modules, or units, or separated into additional components, modules, or units.

According to an embodiment of the present disclosure, a “module” or “unit” may be implemented by a processor and a memory, and may be implemented as a circuit (circuit, circuitry). The term “circuit (circuit, circuitry)” may refer to a hardware circuit but may also refer to a software circuit. The “processor” should be broadly construed to include a general-purpose processor, a central processing unit (CPU), a microprocessor, a digital signal processor (DSP), a controller, a microcontroller, or a state machine. In some environments, the “processor” may denote an application-specific integrated circuit (ASIC), a programmable logic device (PLD), or a field-programmable gate array (FPGA). The “processor” may also denote a combination of processing devices such as a combination of a DSP and a microprocessor, a combination of multiple microprocessors, a combination of one or more microprocessors combined with a DSP core, or any other such configuration. The “memory” should be broadly construed to include any electronic component capable of storing electronic information. The “memory” may denote various types of processor-readable media such as random-access memory (RAM), read-only memory (ROM), non-volatile RAM (NVRAM), programmable ROM (PROM), erasable PROM (EPROM), electrically erasable PROM (EEPROM), flash memory, magnetic or optical data storage devices, or registers. If a processor may read information from or write information to a memory, the memory is said to be in electronic communication with the processor. A memory integrated in a processor is in electronic communication with the processor.

In the present disclosure, a “system” may include at least one of a server device or a cloud device, but is not limited thereto. For example, the system may be composed of one or more server devices. In another example, the system may be composed of one or more cloud devices. In still another example, the system may be configured in such a manner that a server device and a cloud device operate together. In yet another example, the system may refer to a client device for automatically detecting a CIP for three-dimensional reconstruction of cardiovascular images.

Terms such as first, second, A, B, (a), and (b) used in the embodiments below are used only to distinguish one component from another, and the nature, order, or sequence of the components is not limited by the terms.

In addition, when it is described that a component is “connected,” “coupled,” or “linked” to another component in the following embodiments, the component may be directly connected or coupled to the other component, but it should be understood that another component may be “connected,” “coupled,” or “linked” between the components.

Moreover, the terms “comprise” and/or “comprising” used in the following embodiments do not exclude the presence or addition of one or more other components, steps, operations, and/or elements.

In the present disclosure, “each of a plurality of A” may refer to each of all components included in the plurality of A, or to each of some components included in the plurality of A. For example, “each of the plurality of images” may refer to each of all images included in the plurality of images, or to each of some images included in the plurality of images.

Before describing various embodiments of the present disclosure, terms used will be described.

In the present disclosure, a “medical image” may refer to an image and/or picture captured for diagnosis, treatment, or prevention of a disease and may include an image and/or picture capturing the inside or outside of a patient's body. For example, a medical image may include all modalities such as an X-ray image, an ultrasound image, a chest radiograph, computed tomography (CT), positron emission tomography (PET), magnetic resonance imaging (MRI), sonography (ultrasound, US), functional MRI (fMRI), a digital pathology whole slide image (WSI), and digital breast tomosynthesis (DBT). In some embodiments, a “medical image” may include an image capturing a patient's blood vessels after a contrast agent is administered to the patient.

In the present disclosure, a “correspondence point” may represent a common characteristic point included in each of a plurality of two-dimensional images and may be used to reconstruct the two-dimensional images into a three-dimensional image. For example, when a characteristic point extracted as a branch point in one medical image among a plurality of two-dimensional cardiovascular medical images is determined to be common with a characteristic point extracted as a branch point in another medical image, the points may be determined as correspondence points that are matched to each other and may be used to reconstruct the cardiovascular images into a three-dimensional image. In the present disclosure, a correspondence point may include a CIP (Common Image Point).

In the present disclosure, a “patch image” may refer to a partial region within a medical image and may include a region corresponding to a semantic object extracted by performing segmentation on the medical image. For example, the patch image may include an object associated with the cardiovascular structure or an object associated with a branching point where a branch vessel branches from a main vessel. The patch image may have a predetermined size.

In the present disclosure, a “branch point” or “cardiovascular branch point” may represent a point or location at which a branch vessel branches from a main vessel in the cardiovascular structure, and a “branch point candidate” or “cardiovascular branch point” may represent a coordinate or position value of a region identified as a branch point in a contrast image or picture capturing the cardiovascular structure.

In the present disclosure, a “model” may refer to a machine learning model. For example, the model may refer to a neural network model.

Various embodiments of the present disclosure will now be described in detail with reference to the accompanying drawings.

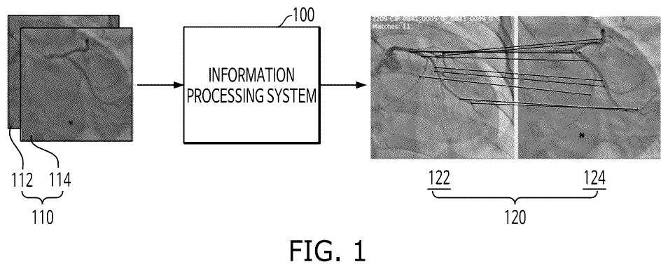

FIG. 1 illustrates an example, according to an embodiment of the present disclosure, of a method by which an information processing system 100 acquires matching data 120 based on a plurality of medical images 112 and 114. The matching data 120 may include matching information indicating that feature points extracted from a third medical image 122 and feature points extracted from a fourth medical image 124 correspond to each other. Here, the first medical image 112 and the third medical image 122 may correspond, and the second medical image 114 and the fourth medical image 124 may correspond.

As illustrated in FIG. 1, the information processing system 100 may be a system equipped with a function of matching feature points in a medical image in which the cardiovascular structure is captured, or a device or system providing a service of matching feature points.

In an embodiment, the information processing system 100 may acquire input data 110 including a first medical image 112 and a second medical image 114. For example, after a patient's cardiovascular structure is captured through imaging device, input data 110 including the first medical image 112 and the second medical image 114 capturing a specific cardiovascular structure may be input to the information processing system 100. For example, input data 110 including the first medical image 112 and the second medical image 114 capturing a specific cardiovascular structure may be provided to the information processing system 100 via a device connected with the imaging device. In another example, the medical images may be provided to the information processing system 100 from a recording medium in which the input data 110 is stored. The manner in which the information processing system 100 acquires the plurality of medical images 112 and 114 capturing the cardiovascular structure is not limited to the examples described above and may be any manner. In addition, the example in which the information processing system 100 receives input data 110 including two medical images 112 and 114 and acquires matching data 120 between the images is for convenience of explanation, and the information processing system 100 may receive medical data including three or more medical images and acquire matching data among three or more images. Here, the input data 110 may include a plurality of X-ray images capturing one person's cardiovascular structure from one direction and/or multiple directions through imaging device.

The information processing system 100 may, using at least one machine learning model, extract a first patch image from the first medical image 112 and a second patch image from the second medical image 114, perform first matching between a plurality of patch images based on their similarity, which involves matching the first patch image and the second patch image, and then perform second matching between a first feature point extracted from the first patch image and a second feature point extracted from the second patch image. Here, the first matching refers to matching a plurality of patch images to each other based on the similarity between the patch images and may be referred to as coarse matching. The second matching refers to determining feature points included in the plurality of patch images as correspondence points matched to each other and may be referred to as fine matching.

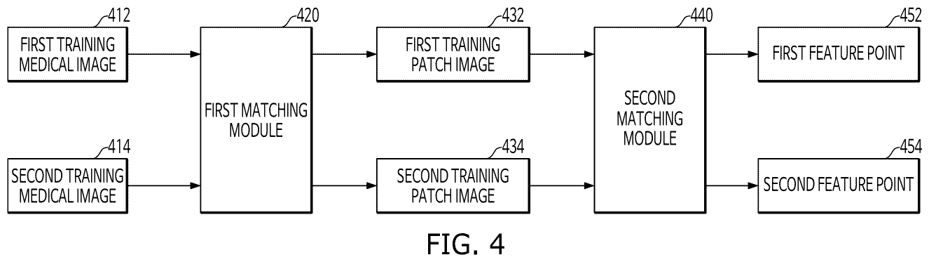

In an embodiment, the machine learning model may determine, as an allowable range within which a feature point can be moved, a second range different from a first range associated with at least one of the first patch image or the second patch image, and may be configured to move at least one of the first feature point or the second feature point within the determined second range. In an embodiment, the machine learning model may move an initially determined first feature point from the first training image to a target point and move an initially determined second feature point from the second training image to a target point. Here, the target point may be a point associated with a ground truth label. The manner in which the first matching and/or second matching is performed through the machine learning model will be described in detail with reference to FIGS. 4 to 9.

In an embodiment, matching data 120 including correspondence points may be used to reconstruct a three-dimensional image based on two-dimensional medical images.

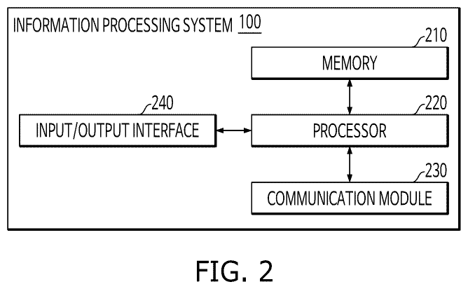

FIG. 2 is a block diagram illustrating an information processing system 100 that provides a correspondence point automatic matching service for three-dimensional reconstruction of medical images according to an embodiment of the present disclosure. The information processing system 100 may include a memory 210, a processor 220, a communication module 230, and an input/output interface 240. As shown in FIG. 2, the information processing system 100 may be configured to communicate information and/or data over a network using the communication module 230.

The memory 210 may include any non-transitory, computer-readable recording medium. In an embodiment, the memory 210 may include a permanent mass storage device such as a disk drive, a solid-state drive (SSD), or flash memory. In another example, a non-volatile mass storage device such as a ROM, SSD, flash memory, or disk drive may be included in the information processing system 100 as a separate permanent storage device distinct from the memory. The memory 210 may store an operating system and at least one program code (for example, program code for executing first matching operations and second matching operations executed in the information processing system 100). Although the memory 210 is illustrated as a single memory in FIG. 2 for convenience, the memory 210 may include a plurality of memories and/or buffer memories.

These software components may be loaded from a computer-readable recording medium separate from the memory 210. Such a separate computer-readable recording medium may include a recording medium directly connectable to the information processing system 100, such as a floppy drive, a disk, a tape, a DVD/CD-ROM drive, or a memory card. In another example, the software components may be loaded into the memory 210 via the communication module 230 rather than the computer-readable recording medium. For example, at least one program may be loaded into the memory 210 based on a computer program installed by files provided through the communication module 230 by developers or a file distribution system that distributes installation files for an application.

The processor 220 may be configured to process commands of computer programs by performing basic arithmetic, logic, and input/output operations. The commands may be provided to the processor 220 by the memory 210 or the communication module 230 from a user terminal (not shown) or another external system. For example, the processor 220 may train at least one machine learning model based on training data including medical images in which the cardiovascular structure is captured.

The communication module 230 may provide a configuration or function for communication between a user terminal (not shown) and the information processing system 100 over a network and may provide a configuration or function for communication between the information processing system 100 and an external system (for example, a separate cloud system). For example, control signals, commands, data, and the like provided under control of the processor 220 of the information processing system 100 may be transmitted to the user terminal and/or the external system through the communication module 230 and the network via the communication module of the user terminal and/or the external system.

The input/output interface 240 of the information processing system 100 may be a means for interfacing with a device (not shown) for input or output connected to or included in the information processing system 100. For example, the input/output interface 240 may include at least one of a PCI Express interface or an Ethernet interface. Although the input/output interface 240 is illustrated as a separate component from the processor 220 in FIG. 2, the input/output interface 240 may be configured to be included in the processor 220. The information processing system 100 may include more components than those in FIG. 2. However, it is unnecessary to clearly illustrate most conventional components.

The processor 220 of the information processing system 100 may be configured to manage, process, and/or store information and/or data received from a plurality of user terminals and/or a plurality of external systems. In an embodiment, the processor 220 may train at least one machine learning model. For example, the processor 220 may acquire a first training patch image and a second training patch image associated with the first training patch image, and, based on the acquired first training patch image and second training patch image, may train a machine learning model such that a first feature point associated with the first training patch image corresponds to a second feature point associated with the second training patch image. In an embodiment, the processor 220 may perform inference on feature point matching using at least one trained machine learning model. For example, the processor 220 may acquire a first patch image and a second patch image associated with the first patch image, input the acquired first patch image and second patch image into the machine learning model, and match a first feature point associated with the first training image with a second feature point associated with the second patch image.

Although the processor 220 is illustrated as a single processor in FIG. 2 for convenience, the processor 220 may include a plurality of processors.

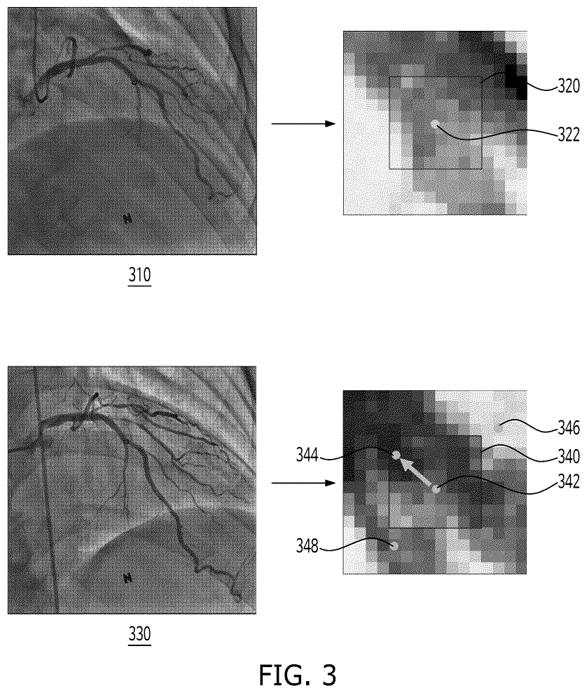

FIG. 3 is an exemplary diagram for explaining first matching and second matching. Referring to FIG. 3, a first patch image 320 may be extracted from a first medical image 310. In an embodiment, a first matching module configured to extract a plurality of patch images from a plurality of medical images and to match a pair of patch images among the extracted plurality of patch images may be used to extract the first patch image 320 from the first medical image 310. The first matching module may be a machine learning model. A detailed description of the first matching module will be given later with reference to FIG. 4. In FIG. 3, the first patch image 320 is illustrated as an image included in a rectangular region. In addition, the first patch image 320 and a second patch image 340 are illustrated as having been processed to grayscale.

Additionally, a second patch image 340 may be extracted from a second medical image 330. The first matching module may be used to extract the second patch image 340 from the second medical image 330. In FIG. 3, the second patch image 340 is illustrated as an image included in a rectangular region.

As illustrated in FIG. 3, the first patch image 320 and the second patch image 340 may have the same size. In FIG. 3, the first patch image 320 and the second patch image 340 are illustrated as having a size of 8×8 pixels. The first patch image 320 and the second patch image 340 may be matched to each other as images having similarity equal to or greater than a threshold. After the first matching performed through the first matching module is completed, second matching associated with point matching may be performed. The second matching may be performed through a second matching module. Here, the second matching module may be a machine learning model. A detailed description of the second matching module will be given later with reference to FIG. 4.

A first center point 322 of the first patch image 320 may be initially determined as a first feature point 322, and a second center point 342 of the second patch image 340 may be initially determined as a second feature point 342. In addition, the initially determined second feature point 342 may be moved to a target point 344. Here, the target point 344 may be a labeled point.

As a machine learning model that performs such first matching and second matching, a Local Feature Transformer (LoFTR) model may be used. However, the LoFTR model may perform second matching only when a target point is located within the second patch image, and may omit second matching when the target point is not located within the second patch image. For example, as illustrated in FIG. 3, if the target point is a point 346 or 348 located outside the second patch image 340, only the first matching may be performed and performing the second matching may be omitted.

In addition, the LoFTR model moves only the second feature point included in the second patch image, and the first feature point included in the first patch image remains fixed without being moved. That is, the LoFTR model assumes that the center point included in the first patch image and the target point coincide with each other, and may ultimately determine the first feature point included in the first patch image as the center point without moving the first feature point. For example, the LoFTR model may move only the second feature point included in the second patch image and match the first feature point at the center and the moved second feature point with each other.

However, when medical images including cardiovascular structures are input to the LoFTR model, a situation in which a target point is not included in the second patch image may occur, and training/inference associated with the second matching may not proceed. In addition, due to the characteristics of medical images, a case may arise in which the center point and the target point do not exactly coincide. For example, referring to FIG. 3, when the center 322 of the first patch image 320 and the target point do not coincide, the first feature point 322 finally determined in the first patch image 320 may be inaccurate.

To prevent the target point from being excluded from the second patch image during the second matching process, in embodiments of the present disclosure, a second matching module determines, as an allowable range within which a feature point can be moved, a second range different from a first range associated with the first patch image or the second patch image, and the second matching module may be configured to move at least one of the first feature point or the second feature point to the target point within the second range for training/inference.

Additionally, to prevent mismatch between the center point and the target point in the first patch image during the second matching process, in embodiments of the present disclosure, the second matching module may be configured to move the initially determined first feature point in the first patch image to a first target point and, additionally, to move the initially determined second feature point in the second patch image to a second target point for training/inference.

FIG. 4 illustrates a method of training a first matching module 420 and a second matching module 440 according to an embodiment of the present disclosure. As illustrated in FIG. 4, a first training medical image 412 and a second training medical image 414 may be input to the first matching module 420. In an embodiment, at least one pixel region and target point may be labeled in each of the first training medical image 412 and the second training medical image 414. For example, a first pixel region associated with a first training patch image 432 and a first target point may be labeled in the first training medical image 412. Likewise, a second pixel region associated with a second training patch image 434 and a second target point may be labeled in the second training medical image 414. The first pixel region and the second pixel region may be labeled as matched, and the first target point and the second target point may be labeled as matched.

The first matching module 420 may extract the first training patch image 432 from the first training medical image 412 and extract the second training patch image 434 from the second training medical image 414, and may associate and match the extracted first training patch image 432 with the second training patch image 434. In an embodiment, the first matching module 420 may divide each of the first training medical image 412 and the second training medical image 414 into sub-images of a predetermined size. Then, the first matching module 420 may calculate similarity between multiple sub-images divided from the first training medical image 412 and multiple sub-images divided from the second training medical image 414, extract a specific sub-image included in the first training medical image 412, which is determined to have similarity equal to or greater than a threshold, as the first training patch image, and extract a specific sub-image included in the second training medical image 414 as the second training patch image. Accordingly, similarity between the first training patch image 432 and the second training patch image 434 may be equal to or greater than a threshold. In some embodiments, the first matching module 420 may extract, as the first training patch image or the second training patch image, a sub-image associated with a predetermined region of interest among the divided sub-images. Here, the region of interest may be at least one of a vessel region or a branch region.

The first matching module 420 may extract multiple training patch images from training medical images and output first matching data in which the multiple training patch images are matched. For example, the first matching module 420 may extract the first training patch image 432, a third training patch image, . . . , and an nth training patch image from the first training medical image 412, and may extract the second training patch image 434, a fourth training patch image, . . . , and an (n+1)th training patch image from the second training medical image 414. In addition, the first matching module 420 may output first matching data in which the first training patch image 432 and the second training patch image 434 are matched, the third training patch image and the fourth training patch image are matched, and the nth training patch image and the (n+1)th training patch image are matched.

A loss value between the first matching data and the labeled matched pixel regions is calculated, and the calculated loss value is reflected in the first matching module 420 so that weights of at least one node included in the first matching module 420 are adjusted. For example, a loss value between the labeled matched first pixel region and second pixel region and the first training patch image 432 and the second training patch image 434 is calculated, and the calculated loss value is reflected in the first matching module 420 so that weights of at least one node included in the first matching module 420 are adjusted.

The first training patch image 432 and the second training patch image 434 may be input to the second matching module 440. In an embodiment, the second matching module 440 may initially determine a center of the first training patch image 432 as a first feature point 452 and move the initially determined first feature point 452 to a labeled first target point. Additionally, the second matching module 440 may initially determine a center of the second training patch image 434 as a second feature point 454 and move the initially determined second feature point 454 to a labeled second target point.

In an embodiment, the second matching module 440 may determine, as an allowable range within which the first feature point 452 or the second feature point 454 can be moved, a second range different from a first range associated with the first training patch image 432 or the second training patch image 434, and may move the first feature point 452 or the second feature point within the second range to a target point. In an embodiment, the second range may be wider than the first range, so that the range in which the first feature point 452 or the second feature point 454 can be moved during second matching is larger than the size of the patch image. In an embodiment, a position of the second range may be determined based on at least one of an area occupied by the first training patch image 432 in the medical image or an area occupied by the second training patch image 434 in the medical image.

The second matching module 440 may output second matching data including the matched first feature point 452 and second feature point 454. A loss value between the second matching result output from the second matching module 440 and the labeled target point is calculated, and the calculated loss value is reflected in the second matching module 440 so that weights of at least one node included in the second matching module 440 are adjusted. For example, a distance or coincidence between the first target point labeled in the first training medical image 412 and the first feature point 452 is calculated as a loss value, and the calculated loss value is reflected in the second matching module 440 so that weights of at least one node included in the first matching module 420 are adjusted. Likewise, a distance or coincidence between the second target point labeled in the second training medical image 414 and the second feature point 454 is calculated as a loss value, and the calculated loss value is reflected in the second matching module 440 so that weights of at least one node included in the first matching module 420 are adjusted.

The learning method described above relates to one training cycle performed on a pair of medical images, and a pair of medical images may be extracted from a plurality of training medical images so that training of the first matching module 420 and the second matching module 440 is performed repeatedly.

Although, in the embodiment described above, the first matching module 420 and the second matching module 440 are illustrated as separate elements, the first matching module 420 and the second matching module 440 may be integrated and implemented as a single machine learning model.

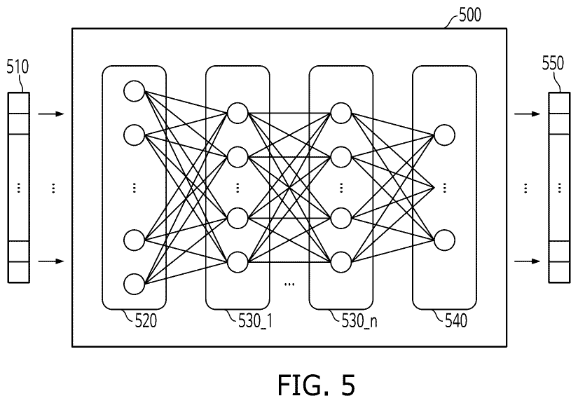

FIG. 5 illustrates, by way of example, an artificial neural-network model 500 according to an embodiment of the present disclosure. The artificial neural-network model 500 is an example of a machine learning model and is a statistical learning algorithm, or a structure executing such an algorithm, implemented based on the structure of a biological neural network in machine learning technology and cognitive science.

According to an embodiment, the artificial neural-network model 500 may represent a machine learning model having a problem-solving capability by repeatedly adjusting synaptic weights between nodes, which are artificial neurons forming a network by synaptic connections as in a biological neural network, so that an error between a correct output corresponding to a specific input and an output inferred by the model is reduced. For example, the artificial neural-network model 500 may include any probabilistic model or neural-network model used in artificial-intelligence learning methods such as machine learning or deep learning.

According to one embodiment, at least one of the first matching module or the second matching module described above may be realized in the form of the artificial neural-network model 500. For example, the artificial neural-network model 500 may receive a first medical image and a second medical image, may be configured to divide each of the first medical image and the second medical image into a plurality of sub-images, and may further be configured to extract a first patch image from the first medical image and a second patch image from the second medical image based on similarity between the divided sub-images and to match the first patch image with the second patch image.

Additionally or alternatively, the artificial neural-network model 500 may receive the first patch image and the second patch image and may be configured to match a first feature point associated with the first patch image with a second feature point associated with the second patch image. In an embodiment, the artificial neural-network model 500 may determine the second range, which is different from the first range associated with at least one of the first patch image or the second patch image, as an allowable movement range for the feature points, and may be configured to move at least one of the first feature point or the second feature point to a target point within the second range.

The artificial neural-network model 500 may be implemented as a multilayer perceptron (MLP) constituted by multiple layers of nodes and connections there-between. The artificial neural-network model 500 according to this embodiment may be implemented using one of various artificial-network model structures including an MLP. As shown in FIG. 5, the artificial neural-network model 500 includes an input layer 520 that receives input signals or data 510 from outside, an output layer 540 that outputs output signals or data 550 corresponding to the input data, and n hidden layers 530_1-530_n (where n is a positive integer) disposed between the input layer 520 and the output layer 540, receiving signals from the input layer 520, extracting features, and delivering the features to the output layer 540. The output layer 540 outputs signals received from the hidden layers 530_1-530_n to the outside.

Learning methods for the artificial neural-network model 500 include a supervised-learning method, in which the model is learned to be optimized for problem solving by inputting teacher signals (ground-truth), and an unsupervised-learning method, which does not require teacher signals. In an embodiment, an information processing system may train the artificial neural-network model 500 using a stored training-data set. For example, the information processing system may extract a pair of medical images from the training-data set and may input the extracted pair of medical images to the artificial neural-network model 500 to train the model.

As such, by matching a plurality of input and output variables at the input layer 520 and the output layer 540 of the artificial neural-network model 500 and by adjusting synaptic values between nodes included in the input layer 520, the hidden layers 530_1-530_n, and the output layer 540, the model may be trained so that a correct output corresponding to a specific input is produced. Through this training process, characteristics hidden in the input variables of the artificial neural-network model 500 can be identified, and the synaptic values (or weights) between the nodes of the artificial neural-network model 500 can be adjusted so that an error between an output variable calculated based on the input variables and a target output is reduced. When a plurality of medical images are input to the trained artificial neural-network model 500, matching data in which a plurality of feature points are matched may be output from the artificial neural-network model 500.

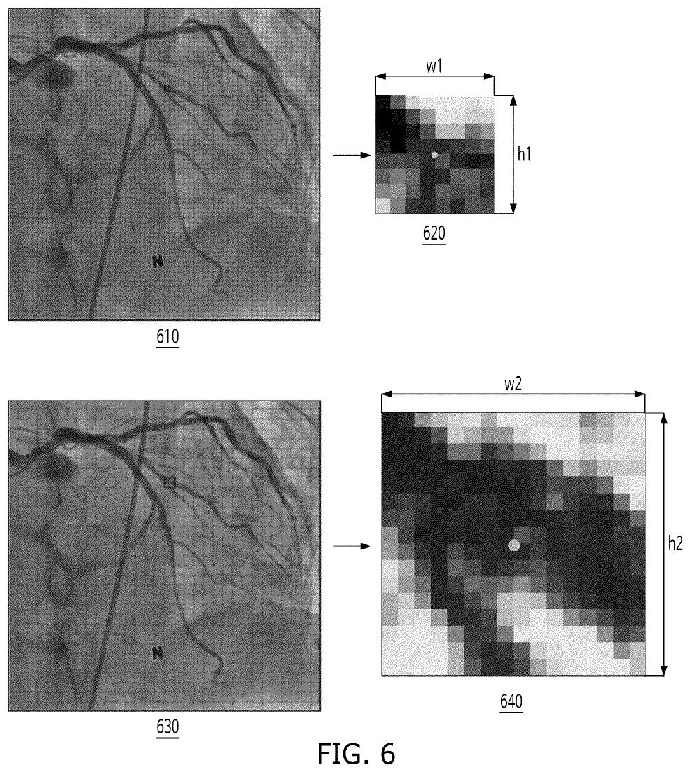

FIG. 6 is a diagram illustrating, by way of example, an enlarged second range according to an embodiment of the present disclosure. Referring to FIG. 6, when a first matching is performed via the first matching module, a patch image 620 associated with a first range may be extracted from a medical image 610. In FIG. 6 the size of the first range is exemplarily w₁×h₁.

When a second matching is performed, a patch image 640 associated with a second range may be extracted from a medical image 630, and the patch image 640 corresponding to the second range may be input to the second matching module. As illustrated in FIG. 6, the second range may be wider than the first range; the size of the second range is exemplarily w₂×h₂. When the patch image 640 having the size of the second range is input to the second matching module, the second matching module may move the feature point within the second range. In some embodiments, a patch image having the size of the first range may be input to the second matching module, the second matching module may determine, as a movement range for the feature point, a second range wider than the first range, and may be configured so that the initially determined feature point is moved within the determined range.

If the first matching is performed based on a patch image 620 having the size of the first range, the performance of the first matching can be improved. In other words, the greater the pixel range, the poorer the performance of the first matching may become; therefore, a patch image 620 having the first range, which is narrower than the second range, may be output via the first matching module for the first matching.

Conversely, the wider the movable range of the feature point, the higher the performance of the second matching can be. Accordingly, for the second matching, a patch image 640 associated with a second range wider than the first range may be extracted from the medical image, and based on the extracted patch image 640 of the second range, the second matching may be performed.

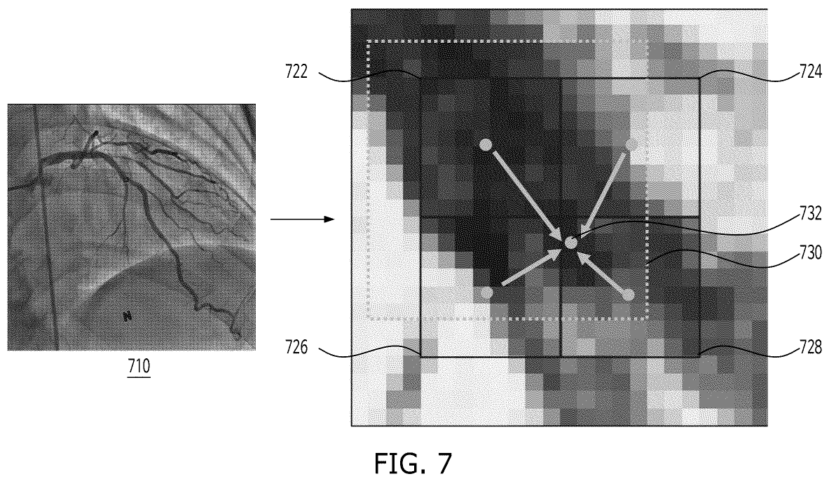

FIG. 7 is a diagram illustrating various examples in which initially determined feature points are moved according to an embodiment of the present disclosure. FIG. 7 shows various patch images 722, 724, 726, 728 extracted from a medical image 710. Each patch image 722, 724, 726, 728 has the size of the first range and is illustrated as an image in a solid-line rectangular region. A point 732 located near the center is illustrated as the target point.

When the first patch image 722 is output from the first matching module, no target point 732 is located in the area associated with the first patch image 722 (that is, the area associated with the first range), so the second matching may fail unless the range is enlarged. Similarly, if the second patch image 724 is output from the first matching module, no target point 732 is located in the area associated with the second patch image 724, so the second matching may fail unless the range is enlarged. Likewise, no target point 732 is located in the area associated with the third patch image 726, so the second matching may fail unless the range is enlarged.

As described above, if the second matching is performed without enlarging the range, the second matching succeeds only when the fourth patch image 728 is extracted, and fails when the first through third patch images 722-726 are extracted. Performing the second matching without range enlargement degrades the accuracy of the second matching during inference and the learning capacity or extent for the second matching may be reduced during training.

In embodiments of the present disclosure, when the second matching is performed, a second range 730, which is enlarged relative to the first range associated with the patch images 722-728, may be determined as an allowable movement range for the feature points. In FIG. 7, the second range 730 is illustrated by a dotted-line rectangle and is shown as having twice the size compared to the first range occupied by one of the patch images 722-728. In an embodiment, the position of the second range 730 may be determined on the basis of the position of the patch image. FIG. 7 shows the second range 730 positioned on the basis of the first patch image 722, and the second range 730 may include the area occupied by the reference first patch image 722.

Within the second range 730, the second matching module may move the initially determined feature point (that is, the center point) in each of the first through third patch images 722-726 to the target point 732. FIG. 7 illustrates that the feature point initially determined from each patch image 722-728 can be moved in the direction indicated by the arrows.

By allowing movement of the feature point within the second range enlarged beyond the first range, the amount of patch image data that can be used for training increases, whereby the training volume for the second matching module increases and inference performance improves.

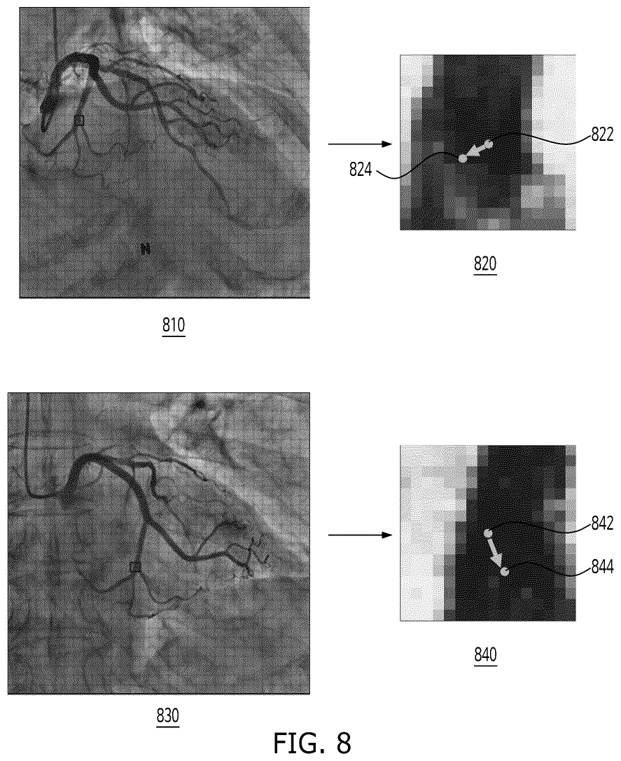

FIG. 8 is a diagram illustrating, by way of example, a method in which a plurality of feature points are moved according to an embodiment of the present disclosure. As illustrated in FIG. 8, in an embodiment, the second matching module may be configured to move both an initially determined first feature point 822 and an initially determined second feature point 842 to target points 824 and 844, respectively.

Specifically, the second matching module may initially determine the first feature point 822 from a first patch image 820 extracted from a first medical image 810 and may move the first feature point 822 to a first target point 824. If the process is a training process, the first target point 824 may be labeled; if the process is an inference process, the position of the target point 824 may be determined by the second matching module. In addition, the second matching module may initially determine the second feature point 842 from a second patch image 840 extracted from a second medical image 830 and may move the second feature point 842 to a second target point 844. In FIG. 8, the first patch image 820 and the second patch image 840 are illustrated as patch images having a size enlarged to the second range.

When the second matching module is configured so that both the first feature point 822 and the second feature point 842 can be moved, even if the center of the first patch image 820 is not the first target point 824, the initially determined first feature point 822 can be moved to the first target point 824, so that the first feature point 822 can be moved to the correct position.

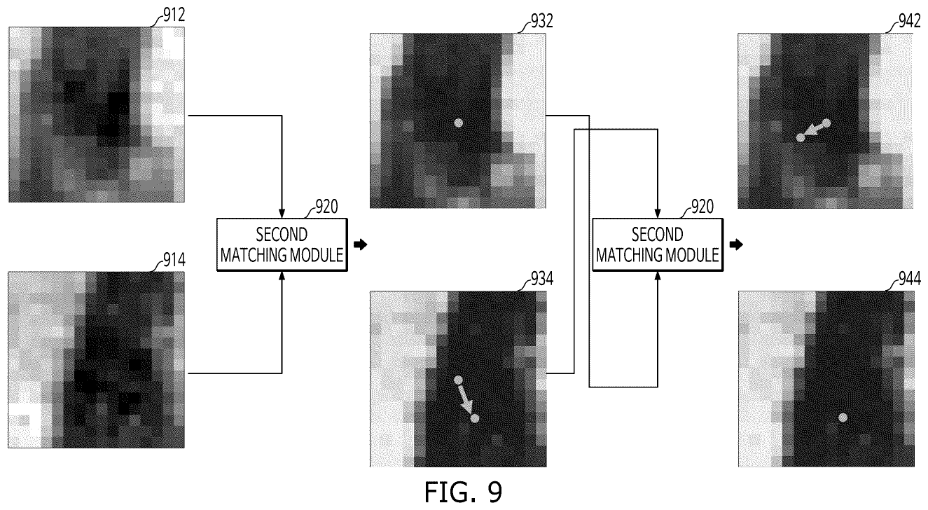

FIG. 9 is a diagram illustrating, by way of example, a method of training the second matching module according to an embodiment of the present disclosure. The second matching module 920 illustrated in FIG. 9 corresponds to the second matching module 440 of FIG. 4.

A pair of a first training patch image 912 and a second training patch image 914 may be input to the second matching module 920. The second matching module 920 may initially determine a first feature point from the first training patch image 912 and may initially determine a second feature point from the second training patch image 914. Next, the second matching module 920 may move the initially determined second feature point to a second target point, and may output a first training patch image 932 and a second training patch image 934 in which the second feature point has been moved. At this time, the second matching module 920 may be trained to move the initially determined second feature point to the second target point.

Subsequently, the second training patch image 934 in which the second feature point has been moved and the first training patch image 932 may be input to the second matching module 920, the second matching module 920 may move the initially determined first feature point to a first target point, may determine the first feature point and the second feature point as corresponding points, and may output matching data including the determined plurality of points. In an embodiment, the second matching module 920 may be trained to move the initially determined first feature point to the first target point. The matching data may include the first training patch image 942 in which the first feature point has been moved and the second training patch image 944 in which the second feature point has been moved.

In summary, a pair of training patch images before movement to target points may be input to the second matching module 920 to train the module, and then a training patch image after movement to the target point and a training patch image before movement may be input to the second matching module 920 for additional training. When such sequential training is conducted, the performance of the second matching module 920 can be further improved.

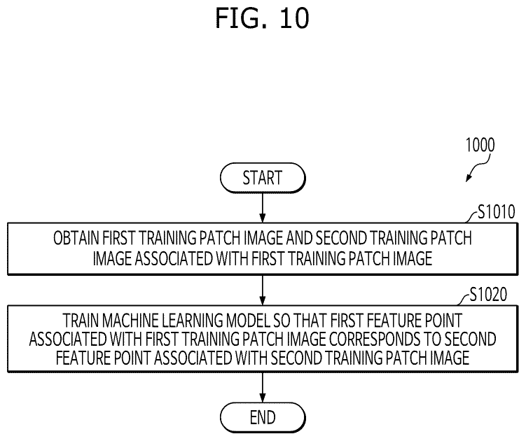

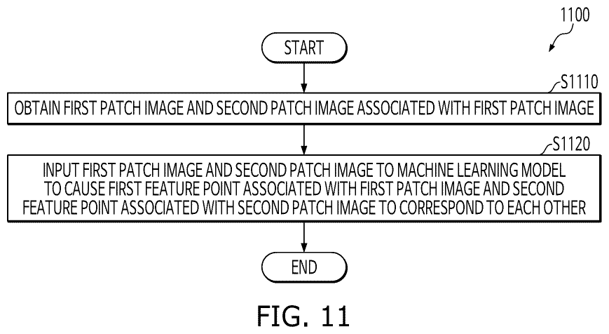

Hereinafter, with reference to FIGS. 10 and 11, methods for matching correspondence points will be explained. The methods shown in FIGS. 10 and 11 are merely exemplary to achieve the object of the disclosure, and some steps may be added or deleted as necessary. The methods shown in FIGS. 10 and 11 may be performed by at least one processor included in an information processing system. For convenience of explanation, it is assumed that each step illustrated in FIGS. 10 and 11 is performed by the processor included in the information processing system illustrated in FIG. 2.

FIG. 10 is a flowchart illustrating a learning method 1000 for matching correspondence points according to an embodiment of the present disclosure. A processor may obtain a first training patch image and a second training patch image associated with the first training patch image (S1010). In some embodiments, the processor may obtain, from a medical image, the second training patch image having a size associated with the second range. In such a case, the second training patch image having the size associated with the second range and the first training patch image may be input to a machine learning model.

Subsequently, based on the obtained first training patch image and second training patch image, the processor may train the machine learning model so that a first feature point associated with the first training patch image corresponds to a second feature point associated with the second training patch image (S1020). In an embodiment, the machine learning model may be configured to determine, as an allowable movement range for a feature point, a second range different from a first range associated with at least one of the first training patch image or the second training patch image. The machine learning model may also be trained to move at least one of the first feature point or the second feature point to a target point within the determined second range. In an embodiment, the machine learning model may be trained to move a first feature point initially determined from the first training patch image to a first target point, and to move a second feature point initially determined from the second training patch image to a second target point.

In an embodiment, the first feature point initially determined is the center of the first training patch image, and the second feature point initially determined is the center of the second training patch image. In an embodiment, the second range is wider than the first range and may be determined based on an area occupied by the first training patch image in the medical image.

In some embodiments, the processor may input the first training patch image and the second training patch image to the machine learning model to train the model so that the second feature point is moved to the second target point. The processor may also input the second training patch image, in which the second feature point has been moved, and the first training patch image to the machine learning model to train the model so that the first feature point is moved to the first target point.

In an embodiment, when it is determined that the target point is located within the second range, the machine learning model may be trained so that the first feature point and the second feature point correspond.

FIG. 11 is a flowchart illustrating a method 1100 of matching correspondence points by using the machine learning model according to an embodiment of the present disclosure. A processor may obtain a first patch image and a second patch image associated with the first patch image (S1110).

Then, the processor may input the obtained first patch image and second patch image to the machine learning model to cause the first feature point associated with the first patch image and the second feature point associated with the second patch image to correspond to each other (S1120).

In an embodiment, the machine learning model may be configured to determine, as a movement range for a feature point, a second range different from a first range associated with at least one of the first patch image or the second patch image, and to move at least one of the first feature point or the second feature point to a target point within the second range. The machine learning model may also be configured to extract a first target point from the first patch image and a second target point from the second patch image. In an embodiment, the machine learning model may be configured to move the first feature point to the first target point and to move the second feature point to the second target point.

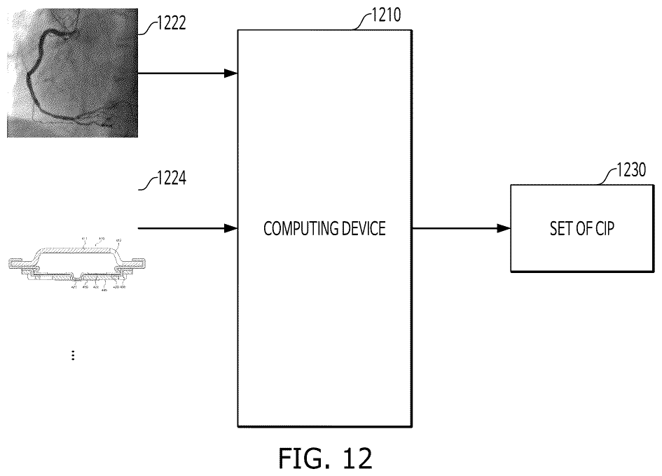

FIGS. 12 through 20 describe a method and system that utilize vascular information (for example, center-line information or contour information) related to medical images (for example, images capturing a specific cardiovascular structure) to match one or more points between medical images, thereby providing correspondence points (for example, a CIP set).

FIG. 12 illustrates, by way of example, a method in which a computing device 1210 obtains a CIP set 1230 based on a plurality of images 1222, 1224 in which a cardiovascular structure is captured according to an embodiment of the present disclosure. As shown in FIG. 12, the computing device 1210 may be a system having a matching function for feature points in medical images capturing cardiovascular structures or may be a device or system that provides a service for matching feature points. For example, the computing device 1210 may receive a first image 1222 and a second image 1224 capturing a specific cardiovascular structure. The computing device 1210 may obtain vascular information (for example, center-line information) respectively from the first image 1222 and the second image 1224, may generate a plurality of feature vectors corresponding to the respective images based on the obtained vascular information, and then, by associating one or more points among the received images with each other on the basis thereof, may determine correspondence points, for example, the CIP set 1230. The obtained CIP set 1230 may be used to reconstruct a three-dimensional image based on two-dimensional cardiovascular images. For convenience of explanation below, it is assumed that the medical images are images capturing a specific cardiovascular structure and that the vascular information related to the medical images is center-line information; however, the medical images and vascular information according to the present disclosure are not limited thereto.

In an embodiment, after a patient's cardiovascular structure is imaged through imaging device, the first image 1222 and the second image 1224 capturing the specific cardiovascular structure may be input to the computing device 1210. For example, the first image 1222 and the second image 1224 may be provided to the computing device 1210 through a device connected to the imaging device. Alternatively, the images may be provided to the computing device 1210 from a recording medium in which the images have been stored in advance. The method by which the computing device 1210 obtains the plurality of cardiovascular images 1222, 1224 is not limited to the above examples and may be any suitable method. Although an example is described in which two images are received and matching data between them are obtained, this is only for convenience of explanation; the computing device 1210 may receive three or more images and may obtain, based on the received images, a CIP set 1230 among the images. Here, the plurality of images 1222, 1224 in which a cardiovascular structure is captured may be a plurality of X-ray images taken from one or more directions of a person's cardiovascular structure through the imaging device.

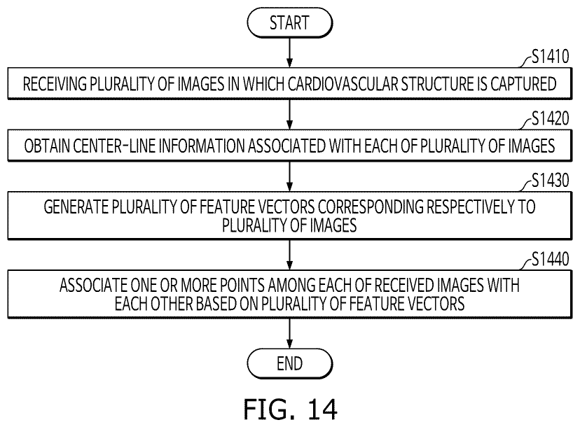

In an embodiment, the computing device 1210 may generate a plurality of feature vectors corresponding respectively to the plurality of images 1222, 1224. For example, the computing device 1210 may obtain center-line information for each of the plurality of images 1222, 1224. Then, based on the center-line information, the computing device 1210 may generate a plurality of feature vectors corresponding respectively to the plurality of images. A detailed method for generating the plurality of feature vectors corresponding respectively to the plurality of images 1222, 1224 in which a cardiovascular structure is captured is described in detail with reference to FIGS. 14 through 18.

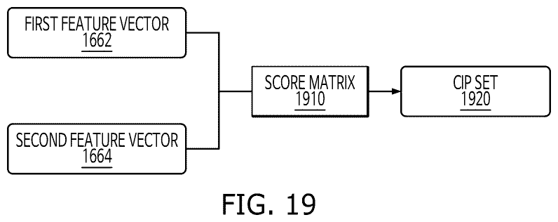

In an embodiment, based on the plurality of feature vectors, the computing device 1210 may associate one or more points among each of the received images 1222, 1224 with each other. For example, by determining correlation coefficients among the plurality of feature vectors, the computing device 1210 may generate a score matrix. Then, based on the generated score matrix, the computing device 1210 may determine one or more points in each of the received images 1222, 1224 as the CIP set 1230. A detailed method of associating one or more points among each of the received images 1222, 1224 with each other based on the plurality of feature vectors to determine the CIP set is described in detail with reference to FIGS. 14 and 19.

Through this configuration, the CIP matching pairs for generating a three-dimensional image of a cardiovascular structure can be automatically generated by matching candidate feature points with each other, using only a portion of vascular information (for example, center-line information or contour information) within cardiovascular images, without a separate step of detecting candidate feature points. Therefore, the effort and cost required to obtain CIP matching pairs can be greatly reduced. In addition, by using relative positional information among a plurality of patch images generated based on vascular information within cardiovascular images for matching candidate feature points, the matching quality of feature points can be improved even in cardiovascular images in which feature points are difficult to discriminate.

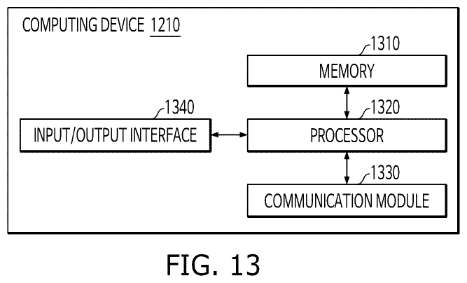

FIG. 13 is a block diagram illustrating a computing device 1210 that provides a CIP automatic-detection service for three-dimensional reconstruction of cardiovascular images according to an embodiment of the present disclosure. The computing device 1210 may include a memory 1310, a processor 1320, a communication module 1330, and an input/output interface 1340. As shown in FIG. 13, the computing device 1210 may be configured to communicate information and/or data over a network by using the communication module 1330.

The memory 1310 may include any non-transitory computer-readable recording medium. In an embodiment, the memory 1310 may include a permanent mass-storage device such as a disk drive, solid-state drive (SSD), or flash memory. Alternatively, a non-volatile mass-storage device such as a ROM, SSD, flash memory, or disk drive may be included in the computing device 1210 as a separate permanent storage device distinct from the memory. The memory 1310 may store an operating system and at least one program code (for example, program code for performing operations of a patch image extractor, a transformer model, or a matching model driven in the computing device 1210). Although, in FIG. 13, the memory 1310 is illustrated as a single memory, this is only for convenience of description; the memory 1310 may include a plurality of memories and/or buffer memories.

The software components may be loaded from a computer-readable recording medium separate from the memory 1310. Such a separate computer-readable recording medium may include a recording medium that can be directly connected to the computing device 1210, such as a floppy drive, disk, tape, DVD/CD-ROM drive, or memory card. Alternatively, the software components may be loaded into the memory 1310 via the communication module 1330 rather than a computer-readable recording medium. For example, at least one program may be loaded into the memory 1310 based on a computer program installed by files supplied through a file-distribution system that provides installation files of applications or other software via the communication module 1330, such as programs for transmitting data such as cardiovascular-imaged data, etc.

The processor 1320 may be configured to process commands of a computer program by performing basic arithmetic, logic, and input/output operations. Commands may be provided by a user terminal (not shown) or another external system via the memory 1310 or the communication module 1330. For example, the processor 1320 may train a patch image extractor, transformer model, and/or matching model based on training data including images of a cardiovascular structure.

The communication module 1330 may provide a configuration or function for communication between a user terminal (not shown) and the computing device 1210 over a network, and may provide a configuration or function for communication between the computing device 1210 and an external system (for example, a separate cloud system). For example, a control signal, command, or data provided under the control of the processor 1320 of the computing device 1210 may be transmitted to the user terminal and/or the external system via the communication module 1330 and the network, through the communication module of the user terminal and/or the external system.

The input/output interface 1340 of the computing device 1210 may serve as means for interfacing between the computing device 1210 and an input or output device (not shown) that is connected to or may be included in the computing device 1210. For example, the input/output interface 1340 may include at least one of a PCI Express interface or an Ethernet interface. Although, in FIG. 13, the input/output interface 1340 is illustrated as a component separate from the processor 1320, the configuration is not limited thereto; the input/output interface 1340 may be configured to be included in the processor 1320. The computing device 1210 may include more components than those illustrated in FIG. 13; however, it is unnecessary to illustrate most conventional components explicitly.

The processor 1320 of the computing device 1210 may be configured to manage, process, and/or store information and/or data received from a plurality of user terminals and/or a plurality of external systems. According to an embodiment, the processor 1320 may obtain a plurality of images in which a cardiovascular structure is captured. The processor 1320 may detect center-line information included in each of the obtained images, and may generate a plurality of feature vectors for each of the images on the basis of the detected center-line information. Then, the processor 1320 may match the feature candidate points in each of the images with each other using the generated feature vectors. Although FIG. 13 illustrates the processor 1320 as a single processor, this is only for the convenience of description, and the processor 1320 may include a plurality of processors.

FIG. 14 is a flowchart illustrating an example of a CIP automatic-matching method according to an embodiment of the present disclosure. The CIP automatic-matching method may be performed by at least one processor (for example, the processor 1320 of FIG. 13) of a computing device. The method may start by receiving a plurality of images in which a cardiovascular structure is captured (S1410). Here, each of the plurality of images may be a different image. Then, the processor may obtain center-line information associated with each of the plurality of images (S1420). Specifically, the processor may identify a first image and a second image included in the plurality of images, and may obtain first center-line information corresponding to the center-line of at least a portion of blood vessels included in the first image and second center-line information corresponding to the center-line of at least a portion of blood vessels included in the second image.

Next, based on the center-line information, the processor may generate a plurality of feature vectors corresponding respectively to the plurality of images (S1430). For example, the processor may generate a first set of patch images based on the first center-line information, and may generate a second set of patch images based on the second center-line information. Here, the first set of patch images may be a plurality of images generated along the center-line of at least a portion of blood vessels included in the first image, and the second set of patch images may be a plurality of images generated along the center-line of at least a portion of blood vessels included in the second image.

The processor may generate a first set of positional embedding vectors corresponding respectively to the patch images of the first set, and, based on the first set of positional embedding vectors, may generate a first feature vector by using a transformer model. Each positional embedding vector of the first set may include relative position information with respect to a start point of the center-line of at least a portion of blood vessels included in the respective patch image of the first set.

In addition, the processor may generate a second set of positional embedding vectors corresponding respectively to the patch images of the second set, and, based on the second set of positional embedding vectors, may generate a second feature vector by using the transformer model. Each positional embedding vector of the second set may include relative position information with respect to a start point of the center-line of at least a portion of blood vessels included in the respective patch image of the second set.

Then, based on the plurality of feature vectors, the processor may associate one or more points among each of the received images with each other (S1440). Specifically, by determining correlation coefficients among the plurality of feature vectors, the processor may generate a score matrix. Then, based on the generated score matrix, the processor may select one or more points in each of the received images as a CIP set. For example, if each of one or more scores among the plurality of scores in the score matrix is equal to or greater than a predetermined threshold, the processor may select, as the CIP set, the points in each of the respective images that are associated with each of the one or more scores.

The flowchart of FIG. 14 and the above description are merely exemplary; in some embodiments, the steps may be implemented differently. For example, in some embodiments, the order of the steps may be changed, some steps may be repeated, some steps may be omitted, or additional steps may be included.

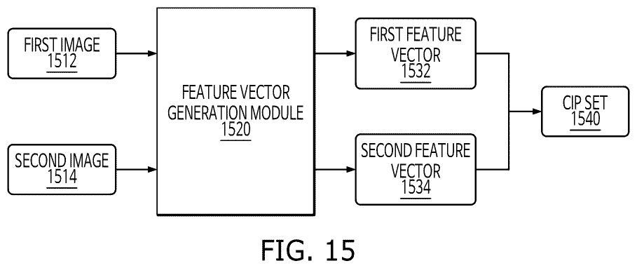

FIG. 15 is a diagram illustrating, by way of example, a method of obtaining a CIP set 1540 based on a first image 1512 and a second image 1514 in which a cardiovascular structure is captured according to an embodiment of the present disclosure. In an embodiment, a processor (for example, the processor 1320 of FIG. 13) may input the plurality of images 1512, 1514 to a feature vector generation module 1520 to generate a plurality of feature vectors 1532, 1534 corresponding respectively to the images. Here, each image among the plurality of images may be a different image; for example, the first image 1512 and the second image 1514 may be images of the same cardiovascular structure captured from different angles. In another example, the first image 1512 and the second image 1514 may be images capturing different cardiovascular structures.

The processor may obtain center-line information associated with each of the plurality of images 1512, 1514. Then, based on the center-line information, the processor may generate the plurality of feature vectors 1532, 1534 corresponding respectively to the images 1512, 1514. For example, the processor may generate a first feature vector 1532 corresponding to the first image 1512 based on center-line information associated with the first image 1512, and may generate a second feature vector 1534 corresponding to the second image 1514 based on center-line information associated with the second image 1514.

In an embodiment, the processor may associate one or more points among each of the received images 1512, 1514 with each other based on the plurality of feature vectors 1532, 1534. For example, by determining correlation coefficients between the first feature vector 1532 and the second feature vector 1534, the processor may generate a score matrix. Then, based on the generated score matrix, the processor may select one or more points in each of the first image 1512 and the second image 1514 as the CIP set 1540. The determined CIP set 1540 may be used to reconstruct a two-dimensional cardiovascular image into a three-dimensional image.

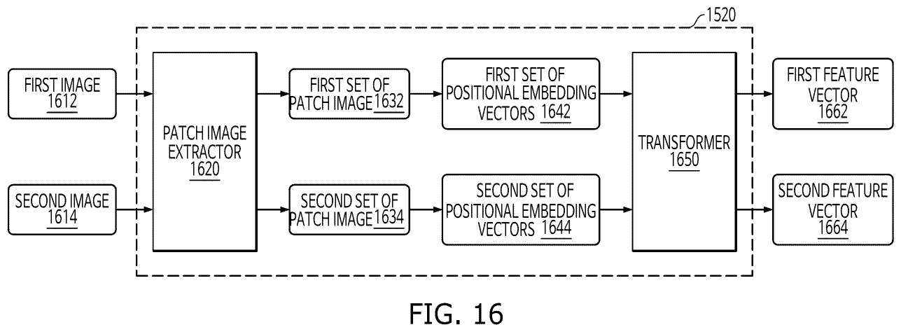

FIG. 16 is a diagram illustrating, by way of example, a detailed method of generating a plurality of feature vectors 1662, 1664 based on a plurality of images 1612, 1614 in which a cardiovascular structure is captured according to an embodiment of the present disclosure. In an embodiment, a processor (for example, the processor 1320 of FIG. 13) may input the plurality of images 1612, 1614 to a feature vector generation module 1520 to generate the plurality of feature vectors 1662, 1664 corresponding respectively to the images 1612, 1614. Here, each image among the plurality of images may be different.

In an embodiment, the feature vector generation module 1520 may include a patch image extractor 1620. The processor may input the plurality of images 1612, 1614 to the patch image extractor 1620 to generate a plurality of patch images 1632, 1634 corresponding respectively to the images. In this case, the patch image extractor 1620 may obtain first center-line information corresponding to the center-line of at least a portion of blood vessels included in the first image 1612 among the plurality of images 1612, 1614, and may generate a first set of patch images 1632 based on the first center-line information. Likewise, the patch image extractor 1620 may obtain second center-line information corresponding to the center-line of at least a portion of blood vessels included in the second image 1614 among the plurality of images 1612, 1614, and may generate a second set of patch images 1634 based on the second center-line information. Here, the first set of patch images 1632 may be a plurality of images generated along the center-line of at least a portion of blood vessels included in the first image 1612, and the second set of patch images 1634 may be a plurality of images generated along the center-line of at least a portion of blood vessels included in the second image 1614.

In an embodiment, the feature vector generation module 1520 may include a transformer model 1650 that outputs the plurality of feature vectors 1532, 1534 corresponding respectively to the images 1612, 1614. Alternatively, although not included in the feature vector generation module 1520, the transformer model 1650 may be accessed and used through the feature vector generation module 1520. The processor may generate a plurality of positional embedding vectors 1642, 1644 corresponding respectively to the patch images 1632, 1634 based on the plurality of patch images 1632, 1634. For example, the processor may generate a first set of positional embedding vectors 1642 corresponding respectively to the patch images of the first set 1632, and may generate a second set of positional embedding vectors 1644 corresponding respectively to the patch images of the second set 1634. Each of the positional embedding vectors 1642, 1644 may include relative position information with respect to a start point of the center-line of at least a portion of blood vessels. Then, based on the plurality of positional embedding vectors 1642, 1644, the processor may use the transformer model 1650 to generate the plurality of feature vectors 1662, 1664 corresponding respectively to the patch images 1632, 1634. For example, the transformer model 1650 may generate the first feature vector 1662 for the first image 1612 based on the first set of positional embedding vectors 1642, and may generate the second feature vector 1664 for the second image 1614 based on the second set of positional embedding vectors 1644.

The plurality of feature vectors 1662, 1664 generated in this way may be used to determine one or more points in each of the first image 1612 and the second image 1614 as a CIP set based on the score matrix.

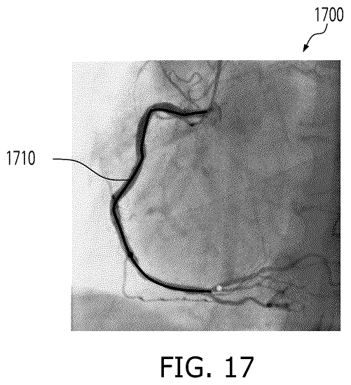

FIG. 17 is a diagram illustrating an example in which center-line information 1710 corresponding to the center-line of a portion of blood vessels included in an image 1700 in which a cardiovascular structure is captured is extracted according to an embodiment of the present disclosure. In an embodiment, a processor (for example, the processor 1320 of FIG. 13) may extract center-line information 1710 corresponding to the center-line of at least a portion of blood vessels included in the image 1700 in order to generate a plurality of patch images for the image 1700. Any segmentation technique known in the art may be used to obtain the center-line information 1710 corresponding to at least a portion of blood vessels included in the image 1700 in which a cardiovascular structure is captured.

As illustrated, the processor may obtain center-line information 1710 corresponding to the center-line of a main blood vessel among cardiovascular vessels included in the image 1700. In this case, the center-line information 1710 may include position information for a plurality of points corresponding to the center-line of the main blood vessel within the image 1700.

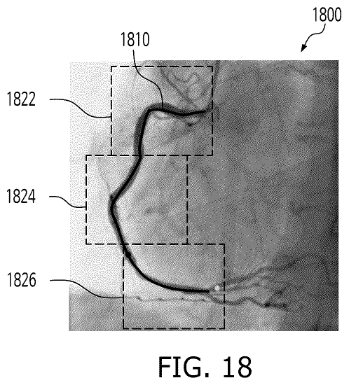

FIG. 18 is a diagram illustrating an example in which a plurality of patch images 1822, 1824, 1826 are generated for the center-line of a portion of blood vessels included in an image 1800 in which a cardiovascular structure is captured according to an embodiment of the present disclosure. In an embodiment, a processor (for example, the processor 1320 of FIG. 13) may generate a plurality of patch images 1822, 1824, 1826 based on center-line information 1810 corresponding to the center-line of a portion of blood vessels included in the image 1800 in which a cardiovascular structure is captured. As illustrated, the processor may generate a first patch image 1822, a second patch image 1824, and a third patch image 1826 based on the center-line information 1810 corresponding to the center-line of the main blood vessel included in the image 1800 in which a cardiovascular structure is captured. In another example, the first patch image 1822, the second patch image 1824, and the third patch image 1826 may be generated using information extracted from an intermediate layer of a segmentation network, which is trained to extract the main blood vessel from the image 1800 which a cardiovascular structure is captured

In an embodiment, each of the plurality of patch images 1822, 1824, 1826 may be generated so as to include a characteristic point of the center-line of the main blood vessel. For example, each of the patch images 1822, 1824, 1826 may be generated so as to include one branching point at which a side branch branches from the main blood vessel. In another example, each of the patch images 1822, 1824, 1826 may be generated so as to include a point at which the center-line of the main blood vessel bends by an angle equal to or greater than a threshold. Although FIG. 18 illustrates an example in which three patch images are generated based on the center-line information 1810, the number of patch images is not limited thereto and may be three or more or fewer.

In an embodiment, each of the plurality of patch images 1822, 1824, 1826 may be generated with a predetermined size so as to include a characteristic point of the center-line of the main blood vessel. In another embodiment, each of the patch images 1822, 1824, 1826 may be generated with an arbitrary size so as to include a characteristic point of the center-line of the main blood vessel. In this case, the size of each of the patch images 1822, 1824, 1826 may be determined using thickness information of the main blood vessel; however, the method of determining the size of the patch images is not limited thereto, and various methods may be employed.

In an embodiment, the processor may generate a plurality of positional embedding vectors corresponding respectively to the patch images 1822, 1824, 1826 based on the plurality of patch images 1822, 1824, 1826. For example, by performing positional encoding based on the first patch image 1822, the processor may generate a first positional embedding vector. Likewise, by performing positional encoding based on the second patch image 1824 and the third patch image 1826, the processor may generate a second positional embedding vector and a third positional embedding vector, respectively. Each of the positional embedding vectors may include relative position information with respect to a start point of the center-line of at least a portion of blood vessels. For example, the first, second, and third positional embedding vectors may include relative positional information within the image 1800, that is, order information based on the start point of the center-line within the image.

The positional embedding vectors generated in this way may be used to generate feature vectors by using the transformer model. In addition, by matching candidate feature points (for example, candidate branching points) among images using the feature vectors, the processor may determine a CIP set.

FIG. 19 is a diagram illustrating, by way of example, a method of determining a CIP set by using a first feature vector 1662 for a first image in which a cardiovascular structure is captured and a second feature vector 1664 for a second image capturing the cardiovascular structure according to an embodiment of the present disclosure. In an embodiment, a processor (for example, the processor 1320 of FIG. 13) may associate one or more points among each of the received images with each other based on the plurality of feature vectors 1662, 1664. Here, the plurality of feature vectors 1662, 1664 may include the first feature vector 1662 and the second feature vector 1664 generated in the manner described above with reference to FIG. 16.

In an embodiment, the processor may generate a score matrix by determining correlation coefficients among a plurality of feature vectors 1662, 1664. For example, the processor may generate a score matrix 1910 by calculating dual-softmax values based on the first feature vector 1662 for the first image 1612 and the second feature vector 1664 for the second image 1614. Here, the correlation coefficient may represent matching probabilities among a plurality of candidate feature points included in the first and second images. The score matrix may have a number of dimensions corresponding to the number of cardiovascular images captured; for example, if two images are input, the score matrix 1910 may be a two-dimensional matrix; similarly, if three images are input, the score matrix may be a three-dimensional cube. Feature point matches between images may represent common points, such as cardiovascular branching points, included in the images.

Table 1 below illustrates an example of matching candidate feature points based on the score matrix storing correlation coefficients when three candidate feature points are included respectively in a first image (for example, the first image 1612 of FIG. 16) and a second image (for example, the second image 1614 of FIG. 16) in which a cardiovascular structure is captured.

TABLE 1

| | FIRST IMAGE | | | |
|---|---|---|---|---|
| | | FIRST | SECOND | THIRD |
| CATEGORY | | POINT | POINT | POINT |
| SECOND | FIRST POINT | 0.996 | 0.00 | 0.034 |
| IMAGE | SECOND POINT | 0.002 | 0.997 | 0.001 |
| | THIRD POINT | 0.274 | 0.291 | 0.435 |

Referring to Table 1, since the correlation between the first point of the first image and the first point of the second image is highest, the first point of the first image and the first point of the second image may be matched. Likewise, the second point of the first image and the second point of the second image may be matched, and the third points may be matched. Although Table 1 illustrates an example in which candidate feature points between two images in which a cardiovascular structure is captured are matched, candidate branching points may also be matched based on a score matrix among two or more images.

Then, based on the generated score matrix 1910, the processor may determine one or more points in each of the received images as the CIP set 1920. For example, when at least one of the plurality of scores included in the score matrix 1910 is equal to or greater than a predetermined threshold, the processor may select, as the CIP set 1920, the points in the images that are associated with the at least one score. For example, the processor may select as the CIP set 1920 a set of points having a matching probability of 90% or more. In the example of Table 1, since the matching probabilities between the first point of the first image and the first point of the second image, as well as between the second point of the first image and the second point of the second image, are 90% or more, these point sets may be selected as the CIP set 1920. However, the third point of the first image and the third point of the second image have a matching probability of less than 90%, and thus may not be selected as part of the CIP set.

At least part of the feature vector generation module 1520 described with reference to FIGS. 15 and 16 and at least part of the score matrix 1910 described with reference to FIG. 19 may correspond to the first matching module 420 and/or the second matching module 440 described with reference to FIG. 4. For example, in an embodiment of the present disclosure, a processor may acquire a plurality of training patch images having corresponding points, for example, a CIP set 1920, by using at least part of the feature vector generation module 1520 and the score matrix 1910.

In an embodiment, the feature vector generation module 1520 may include a convolutional-neural-network (CNN) module. In that case, the CNN module may extract a plurality of feature maps having different scales by using the plurality of images (for example, the first image 1612 and the second image 1614), and the extracted feature maps may be input to the patch image extractor 1620. For example, the first matching module 420 and/or the second matching module 440 described with reference to FIG. 4 may extract and match a plurality of feature maps having different scales from a plurality of input images by using the CNN module. Here, when referring to FIG. 4, the plurality of input images may include the first training medical image 412 and the second training medical image 414 in the case of the first matching module 420, and the first training patch image 432 and the second training patch image 434 in the case of the second matching module 440. In addition, the plurality of feature maps having different scales may include a first-scale (for example, coarse-scale) feature map extracted from an intermediate layer of the CNN module and a second-scale (for example, fine-scale) feature map extracted from a final layer of the CNN module.

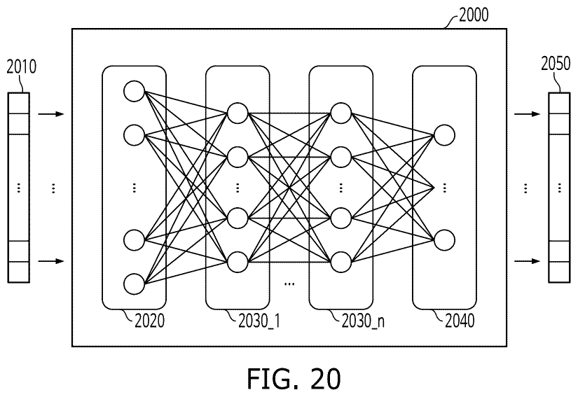

FIG. 20 illustrates, by way of example, an artificial neural-network model 2000 according to an embodiment of the present disclosure. The artificial neural-network model 2000 is an example of a machine learning model and is a statistical learning algorithm, or a structure executing such an algorithm, implemented based on the structure of a biological neural network in machine learning technology and cognitive science.

According to an embodiment, the artificial neural-network model 2000 can represent a machine learning model possessing problem-solving capabilities by repeatedly adjusting synaptic weights among nodes (artificial neurons), which form a network through synaptic connections as in a biological neural network, so that an error between a correct output corresponding to a specific input and an output inferred by the model is minimized. For example, the artificial neural-network model 2000 may include any probabilistic model or neural-network model used in artificial-intelligence learning methods such as machine learning or deep learning.

According to an embodiment, at least one of a patch image extractor, a transformer model, or a matching model described above may be realized in the form of the artificial neural-network model 2000. For example, the patch image extractor may receive one or more images in which a cardiovascular structure is captured, may detect, by using the artificial neural-network model, a region corresponding to the center-line of a portion of the cardiovascular structure (for example, a main blood vessel) within the received image(s), and may generate one or more patch images by using the detected center-line region. The transformer model may generate feature vectors from positional embedding vectors corresponding to the generated patch images. The matching model may calculate relevance scores among candidate feature points (for example, candidate branching points) among images in which a cardiovascular structure is captured based on the feature vectors corresponding to the images.

The artificial neural-network model 2000 may be implemented as a multilayer perceptron (MLP) constituted by multiple layers of nodes and connections there-between. The artificial neural-network model 2000 according to this embodiment may be implemented using one of various artificial-network model structures including an MLP. As shown in FIG. 20, the artificial neural-network model 2000 includes an input layer 2020 that receives input signals or data 2010 from outside, an output layer 2040 that outputs output signals or data 2050 corresponding to the input data, and n hidden layers 2030_1-2030_n (where n is a positive integer) disposed between the input layer 2020 and the output layer 2040, receiving signals from the input layer 2020, extracting features, and delivering the features to the output layer 2040. The output layer 2040 outputs signals received from the hidden layers 2030_1-2030_n to the outside.

Learning methods for the artificial neural-network model 2000 include a supervised-learning method, in which the model is learned to be optimized for problem solving by inputting teacher signals (ground-truth), and an unsupervised-learning method, which does not require teacher signals. In an embodiment, an information processing system may learn the artificial neural-network model 2000 using a plurality of images in which cardiovascular structures are captured.

In an embodiment, the information processing system may directly generate training data for training the artificial neural-network model 2000. For example, to train the artificial neural-network model 2000 used by the patch image extractor, the information processing system may receive one or more images in which a cardiovascular structure is captured, may determine center-lines for a portion of the cardiovascular structure in the images, may generate a training-data set including information on the determined center-lines, and may train the artificial neural-network model 2000 for detecting a center-line of a portion of the cardiovascular structure within one or more images capturing the cardiovascular structure based on the generated training-data set.

The information processing system may generate a training-data set including patch image data (for example, positional embedding vectors) associated with at least a portion of one or more images in which one or more cardiovascular structures are captured in order to train the transformer model, and may train the artificial neural-network model 2000 for generating feature vectors associated with one or more images in which one or more cardiovascular structures are captured based on the generated training-data set.

The information processing system may generate a training-data set including feature vectors associated with images in which cardiovascular structures are captured in order to train the matching model, and may train the artificial neural-network model 2000 for calculating relevance scores among candidate feature points within one or more images in which cardiovascular structures are captured based on the generated training-data set.

In an embodiment, when the artificial neural-network model 2000 is the model used by the patch image extractor, the input variables may include one or more images in which one or more cardiovascular structures are captured. When the input variables described above are input through the input layer 2020, the output variables output by the output layer 2040 may be vectors representing or characterizing candidate feature points within the one or more images in which one or more cardiovascular structures are captured.

Additionally, when the artificial neural-network model 2000 is a transformer model, the input variables may include a training-data set that contains images in which one or more cardiovascular structure are captured and/or patch image data associated with at least a portion of the images in which the cardiovascular structures are captured (for example, positional embedding vectors). When the input variables described above are input via the input layer 2020, the output variables output by the output layer 2040 of the artificial neural-network model 2000 may be vectors characterizing one or more images in which cardiovascular structures are captured.

When the artificial neural-network model 2000 is the matching model, the input variables may include a training-data set including images in which one or more cardiovascular structure are captured and/or feature vectors corresponding to the image capturing the cardiovascular structure. When the input variables described above are input through the input layer 2020, the output variables output by the output layer 2040 of the artificial neural-network model 2000 may be a score matrix representing similarities among candidate feature points included in a plurality of images in which one or more cardiovascular structures are captured.

As such, by matching a plurality of input and output variables at the input layer 2020 and the output layer 2040 of the artificial neural-network model 2000 and by adjusting synaptic values between nodes included in the input layer 2020, the hidden layers 2030_1-2030_n, and the output layer 2040, the model may be trained so that a correct output corresponding to a specific input is produced. Through this training process, characteristics hidden in the input variables of the artificial neural-network model 2000 can be identified, and the synaptic values (or weights) between the nodes of the artificial neural-network model 2000 can be adjusted so that an error between an output variable calculated based on the input variables and a target output is reduced. By using the trained artificial neural-network model 2000, a CIP set may be determined among candidate feature points (for example, candidate branching points) included in a plurality of images in which one or more cardiovascular structures are captured.

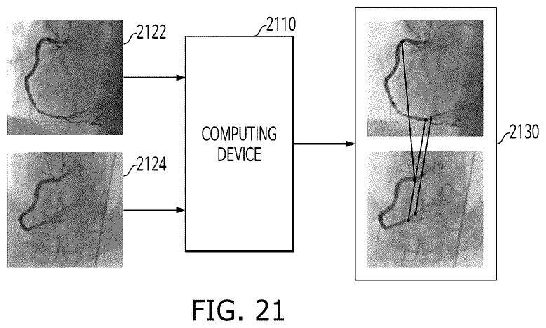

FIGS. 21 through 31 describe a method and system that, by using candidate feature points associated with an image capturing a specific cardiovascular structure and visual descriptors for partial regions of the image, match the candidate feature points among images capturing the same cardiovascular structure so as to provide CIP matching pairs.

FIG. 21 illustrates, by way of example, a method in which a computing device 2110 obtains candidate feature point matching data 2130 based on a plurality of images 2122, 2124 in which a cardiovascular structure is captured according to an embodiment of the present disclosure. As shown in FIG. 21, the computing device 2110 may be a system having a matching function for feature points in images in which a cardiovascular structure is captured or may be a device or system that provides a service for matching feature points. For example, the computing device 2110 may acquire a first image 2122 and a second image 2124 capturing a specific cardiovascular structure. The computing device 2110 may extract candidate feature points from each of the first image 2122 and the second image 2124 and may generate visual descriptors associated with the extracted candidate feature points. Then, based on the extracted candidate feature points and the generated visual descriptors, the computing device 2110 may match the candidate feature points of the first image 2122 with those of the second image 2124 to obtain candidate feature point matching data 2130. The obtained candidate feature point matching data 2130 may be used to reconstruct a three-dimensional image based on two-dimensional cardiovascular images.

In an embodiment, after a patient's cardiovascular structure is imaged through imaging device, the first image 2122 and the second image 2124 capturing the specific cardiovascular structure may be input to the computing device 2110. For example, the first image 2122 and the second image 2124 may be provided to the computing device 2110 through a device connected to the imaging device. Alternatively, the images may be provided to the computing device 2110 from a recording medium in which the images have been stored in advance. The method by which the computing device 2110 obtains the plurality of images 2122, 2124 in which a cardiovascular structure is captured is not limited to the above examples and may be any suitable method. Although, for convenience of explanation, an example is described in which two images are received and matching data between them are obtained, the computing device 2110 may receive three or more images and may obtain feature point matching data among the images based on the received images. Here, the plurality of images 2122, 2124 in which cardiovascular structures are captured may be a plurality of X-ray images taken from one or more directions of a person's cardiovascular structure through the imaging device.

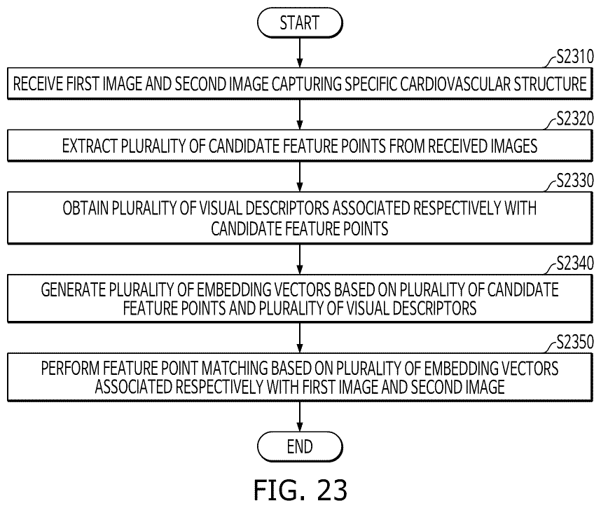

In an embodiment, the computing device 2110 may extract a plurality of candidate feature points and a plurality of visual descriptors based on the plurality of images 2122, 2124 in which cardiovascular structures are captured. For example, the computing device 2110 may use a visual feature detection model to extract a plurality of candidate feature points and may obtain a plurality of visual descriptors by using the extracted candidate feature points. The visual feature detection model may be a machine learning model trained so as to detect, as candidate feature points, one or more points at which a side branch branches from a main blood vessel within the cardiovascular structure in an acquired image. A detailed method for extracting the plurality of candidate feature points and the plurality of visual descriptors based on the plurality of images 2122, 2124 in which a cardiovascular structure is captured is described in detail with reference to FIGS. 23 through 26.

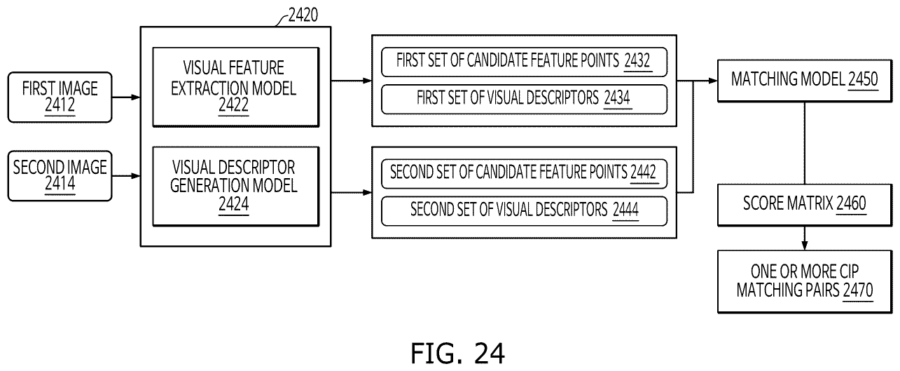

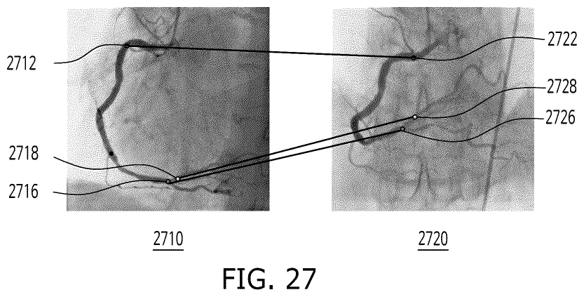

In an embodiment, the computing device 2110 may obtain candidate feature point matching data 2130 among candidate feature points within the plurality of images 2122, 2124 by using the plurality of candidate feature points and the plurality of visual descriptors. For example, the computing device 2110 may generate a plurality of embedding vectors based on the plurality of candidate feature points and the plurality of visual descriptors by using a matching model. In another example, the computing device 2110 may generate a plurality of embedding vectors based on the plurality of candidate feature points, the plurality of visual descriptors, and camera meta information by using the matching model (for example, the matching model 2450 of FIG. 24). Then, by using the matching model, the computing device 2110 may perform feature point matching based on the plurality of embedding vectors associated respectively with the first image 2122 and the second image 2124 to obtain the candidate feature point matching data 2130. A detailed method for obtaining the candidate feature point matching data 2130 among candidate feature points within the plurality of images 2122, 2124 is described in detail with reference to FIGS. 23 and 27.

Through this configuration, candidate feature points of a cardiovascular structure can be detected based on images capturing a specific cardiovascular structure, and CIP matching pairs for generating a three-dimensional image of the cardiovascular structure can be automatically generated by matching the detected candidate feature points with each other. Therefore, the effort and cost required to obtain CIP matching pairs can be greatly reduced. In addition, by detecting candidate feature points within an image capturing a specific cardiovascular structure, generating visual descriptors for a partial region of the image centered on the detected candidate feature points, and using the visual descriptors for matching among candidate feature points, the matching quality of feature points can be improved even in cardiovascular images in which feature points are difficult to discriminate.

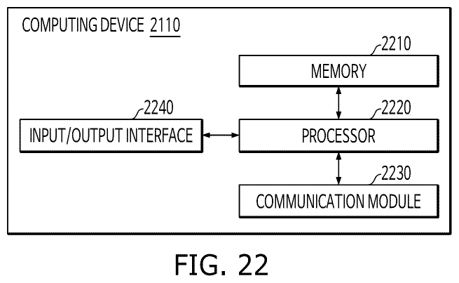

FIG. 22 is a block diagram illustrating a computing device 2110 that provides a CIP automatic-detection service for three-dimensional reconstruction of cardiovascular images according to an embodiment of the present disclosure. The computing device 2110 may include a memory 2210, a processor 2220, a communication module 2230, and an input/output interface 2240. As shown in FIG. 22, the computing device 2110 may be configured to communicate information and/or data over a network by using the communication module 2230.

The memory 2210 may include any non-transitory computer-readable recording medium. In an embodiment, the memory 2210 may include a permanent mass-storage device such as a disk drive, solid-state drive (SSD), or flash memory. Alternatively, a non-volatile mass-storage device such as a ROM, SSD, flash memory, or disk drive may be included in the computing device 2110 as a separate permanent storage device distinct from the memory. The memory 2210 may store an operating system and at least one program code (for example, program code for performing operations of a visual feature detection model, a visual descriptor generation model, or a matching model driven in the computing device 2110). Although, in FIG. 22, the memory 2210 is illustrated as a single memory, this is only for convenience of description; the memory 2210 may include a plurality of memories and/or buffer memories.

The software components may be loaded from a computer-readable recording medium separate from the memory 2210. Such a separate computer-readable recording medium may include a recording medium that can be directly connected to the computing device 2110, such as a floppy drive, disk, tape, DVD/CD-ROM drive, or memory card. Alternatively, the software components may be loaded into the memory 2210 via the communication module 2230 rather than a computer-readable recording medium. For example, at least one program may be loaded into the memory 2210 based on a computer program installed by files supplied through a file-distribution system that provides installation files of applications or other software via the communication module 2230 (for example, a program for transmitting data such as images in which a cardiovascular structure is captured).

The processor 2220 may be configured to process commands of a computer program by performing basic arithmetic, logic, and input/output operations. Commands may be provided by a user terminal (not shown) or another external system via the memory 2210 or the communication module 2230. For example, the processor 2220 may train a visual feature detection model, a visual descriptor generation model, and/or a matching model based on training data including images in which a cardiovascular structure is captured.

The communication module 2230 may provide a configuration or function for communication between a user terminal (not shown) and the computing device 2110 over a network, and may provide a configuration or function for communication between the computing device 2110 and an external system (for example, a separate cloud system). For example, a control signal, command, or data provided under the control of the processor 2220 of the computing device 2110 may be transmitted to the user terminal and/or the external system via the communication module 2230 and the network, through the communication module of the user terminal and/or the external system.

The input/output interface 2240 of the computing device 2110 may serve as means for interfacing between the computing device 2110 and an input or output device (not shown) that is connected to or may be included in the computing device 2110. For example, the input/output interface 2240 may include at least one of a PCI Express interface or an Ethernet interface. Although, in FIG. 22, the input/output interface 2240 is illustrated as a component separate from the processor 2220, the configuration is not limited thereto; the input/output interface 2240 may be configured to be included in the processor 2220. The computing device 2110 may include more components than those illustrated in FIG. 22; however, it is unnecessary to illustrate most conventional components explicitly.

The processor 2220 of the computing device 2110 may be configured to manage, process, and/or store information and/or data received from a plurality of user terminals and/or a plurality of external systems. In an embodiment, the processor 2220 may obtain a plurality of images in which a cardiovascular structure is captured. The processor 2220 may detect candidate feature points included in each of the obtained images, may generate visual descriptors associated with the detected candidate feature points, and may match candidate feature points among different images based on the detected candidate feature points and the generated visual descriptors. Although, in FIG. 22, the processor 2220 is illustrated as a single processor, this is only for convenience of description; the processor 2220 may include a plurality of processors.

FIG. 23 is a flowchart illustrating an example of a CIP automatic-matching method according to an embodiment of the present disclosure. The CIP automatic-matching method may be performed by at least one processor (for example, the processor 2220 of FIG. 22) of a computing device. The method may start by receiving a first image and a second image capturing a specific cardiovascular structure (S2310). Here, the first image and the second image may be different images; for example, the first image and the second image may be cardiovascular angiographic images captured at different angles.

The processor may extract a plurality of candidate feature points from the received images (S2320). For example, the processor may extract a first set of candidate feature points associated with the first image and may extract a second set of candidate feature points associated with the second image.

The processor may obtain a plurality of visual descriptors associated respectively with the candidate feature points (S2330). For example, the processor may obtain a first set of visual descriptors associated respectively with the candidate feature points of the first set and may obtain a second set of visual descriptors associated respectively with the candidate feature points of the second set. In an embodiment, the processor may generate a plurality of visual descriptors for at least a partial region of a specific image centered on the coordinates of each candidate feature point in the plurality of candidate feature points. For example, the processor may generate a first set of visual descriptors for at least a partial region of the first image centered on the coordinates of each candidate feature point in the first set, and may similarly generate a second set of visual descriptors for at least a partial region of the second image centered on the coordinates of each candidate feature point in the second set. In an embodiment, the visual descriptor generation model may include a plurality of sub-models. Each of the plurality of sub-models may be a multi-head model configured to extract visual descriptors for regions having different sizes with respect to at least a partial region of an input image.

The processor may generate a plurality of embedding vectors based on the plurality of candidate feature points and the plurality of visual descriptors (S2340). For example, the processor may generate a first set of embedding vectors based on the first set of candidate feature points and the first set of visual descriptors, and may generate a second set of embedding vectors based on the second set of candidate feature points and the second set of visual descriptors. Specifically, the processor may generate an embedding vector for each candidate feature point by using the visual descriptor associated with the candidate feature point. For example, the processor may identify, among the first set of candidate feature points, a first candidate feature point and may identify a first visual descriptor corresponding to the first candidate feature point among the first set of visual descriptors, and may then generate a first embedding vector based on the coordinate value of the first candidate feature point and the first visual descriptor.

In an embodiment, camera meta information associated with a specific image may be received in the process of generating the plurality of embedding vectors. For example, camera meta information associated with the first image may be received in the process of generating the first set of embedding vectors. In this case, a first embedding vector may be generated based on the coordinate value of the first candidate feature point, the first visual descriptor, and the camera meta information associated with the first image. The camera meta information associated with the first image may include at least one of information on a rotation matrix, a translation matrix, or a focal length associated with the first image.

The processor may perform feature point matching based on the plurality of embedding vectors associated respectively with the first image and the second image (S2350). For example, the processor may perform feature point matching based on the first set of embedding vectors associated with the first image and the second set of embedding vectors associated with the second image. Here, The first set of embedding vectors refers to a plurality of embedding vectors generated by using visual descriptors for each candidate feature point associated with the first set relating to the first image, and the second set of embedding vectors similarly refers to a plurality of embedding vectors generated by using visual descriptors for each candidate feature point associated with the second set relating to the second image. For example, by using the matching model, the processor may generate a score matrix based on similarity scores calculated among respective embedding vectors included in the first set of embedding vectors and the second set of embedding vectors, and may determine CIP matching pairs.

The flowchart of FIG. 23 and the above description are merely exemplary; in some embodiments, the steps may be implemented differently. For example, in some embodiments, the order of the steps may be changed, some steps may be repeated, some steps may be omitted, or additional steps may be included.

FIG. 24 is a diagram illustrating, by way of example, a method of obtaining one or more CIP matching pairs 2470 based on a first image 2412 and a second image 2414 in which a cardiovascular structure is captured according to an embodiment of the present disclosure. In an embodiment, a processor (for example, the processor 2220 of FIG. 22) may input the plurality of images 2412, 2414 to a visual feature extraction model 2420 to extract a plurality of candidate feature points 2432, 2442 and a plurality of visual descriptors 2434, 2444. Here, the visual feature extraction model 2420 may include a visual feature detection model 2422 and a visual descriptor generation model 2424. The visual feature detection model 2422 and the visual descriptor generation model 2424 may share a backbone and may be multi-head models; however, they are not limited thereto and may be separate models.

For example, by using the visual feature detection model 2422, the processor may extract a first set of candidate feature points 2432 based on the first image 2412, and may extract a second set of candidate feature points 2442 based on the second image 2414. Here, the visual feature detection model 2422 may be a machine learning model trained so as to detect, as candidate feature points, one or more points at which a side branch branches from a main blood vessel within the cardiovascular structure of an input image. For example, the visual feature detection model 2422 may be a machine learning model trained to detect candidate feature points in an input image. In another example, the visual feature detection model 2422 may be a machine learning model trained to detect candidate feature points by considering the correspondence among a plurality of input images.

By using the visual descriptor generation model 2424, the processor may generate a first set of visual descriptors 2434 for a region having a predetermined size within the first image 2412 centered respectively on the coordinates of the candidate feature points 2432 of the first set. Likewise, the processor may generate a second set of visual descriptors 2444 for a region having a predetermined size within the second image 2414 centered respectively on the coordinates of the candidate feature points 2442 of the second set.

In an embodiment, the visual descriptor generation model 2424 may include a plurality of sub-models. Each of the plurality of sub-models may be a multi-head model configured to extract visual descriptors for regions having different sizes for at least a partial region of an input image. For example, the visual descriptor generation model 2424 may include a sub-model for generating visual descriptors for a 16×16-pixel region, a sub-model for generating visual descriptors for a 32×32-pixel region, and/or a sub-model for generating visual descriptors for a 48×48-pixel region; however, the model is not limited thereto.

In an embodiment, by using the matching model 2450, the processor may generate a plurality of embedding vectors based on the first set of candidate feature points 2432 and the first set of visual descriptors 2434 of the first image 2412 and the second set of candidate feature points 2442 and the second set of visual descriptors 2444 of the second image 2414. The first set of embedding vectors refers to embedding vectors generated using visual descriptors associated respectively with the candidate feature points of the first set, and the second set of embedding vectors refers to embedding vectors generated using visual descriptors associated respectively with the candidate feature points of the second set.

Specifically, among the first set of candidate feature points 2432, the processor may identify a first candidate feature point, may identify a first visual descriptor corresponding to the first candidate feature point among the first set of visual descriptors 2434, and may then generate a first embedding vector based on the coordinate value of the first candidate feature point and the first visual descriptor. Likewise, among the second set of candidate feature points 2442, the processor may identify a second candidate feature point, may identify a second visual descriptor corresponding to the second candidate feature point among the second set of visual descriptors 2444, and may generate a second embedding vector based on the coordinate value of the second candidate feature point and the second visual descriptor.

In an embodiment, by using the matching model 2450, the processor may generate a plurality of embedding vectors on the basis of the first set of candidate feature points 2432 and the first set of visual descriptors 2434 from the first image (2412), the first camera meta-information, the second set of candidate feature points 2442 and the second set of visual descriptors 2444 from the second image (2414), and the second camera meta-information. Here, the camera meta-information may include at least one of a rotation matrix, a translation matrix, or a focal length associated respectively with each image.

By using the matching model 2450, the processor may perform feature point matching based on the first set of embedding vectors associated with the first image 2412 and the second set of embedding vectors associated with the second image 2414. Specifically, by using the matching model 2450, the processor may generate a score matrix 2460 based on similarity scores calculated between respective embedding vectors included in the first set of embedding vectors and the second set of embedding vectors, and may determine one or more CIP matching pairs 2470.

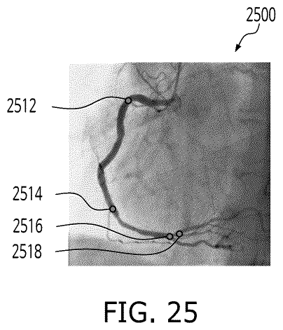

FIG. 25 illustrates, by way of example, a plurality of candidate feature points 2512, 2514, 2516, 2518 extracted based on an image 2500 in which a cardiovascular structure is captured according to an embodiment of the present disclosure. As illustrated, a processor (for example, the processor 2220 of FIG. 22) may extract the plurality of candidate feature points 2512, 2514, 2516, 2518 based on the image 2500. Here, the plurality of candidate feature points 2512, 2514, 2516, 2518 may include one or more points at which a side branch branches from a main blood vessel within the cardiovascular structure, extracted from the image by using a visual feature detection model (for example, a branching-point detection model). For example, as illustrated, by using the visual feature detection model, the processor may detect a first candidate feature point 2512, a second candidate feature point 2514, a third candidate feature point 2516, and a fourth candidate feature point 2518, which branch from the main blood vessel within the cardiovascular structure, based on the image 2500.

In an embodiment, the visual feature detection model may be a machine learning model trained to detect candidate feature points in a single input image. In another embodiment, the visual feature detection model may be a machine learning model trained to detect candidate feature points by considering correspondences and/or correlations among multiple input images.

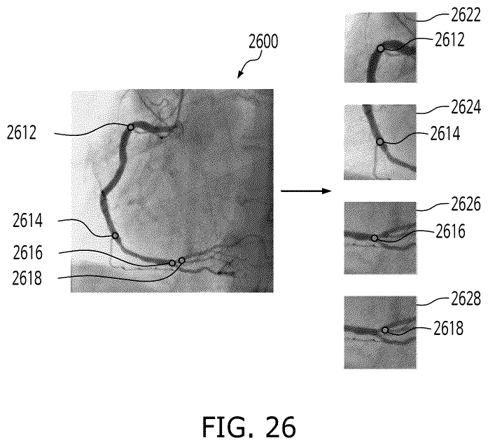

FIG. 26 is a diagram illustrating a method of obtaining a plurality of visual descriptors by using a plurality of candidate feature points 2612, 2614, 2616, 2618 extracted from an image 2600 in which a cardiovascular structure is captured according to an embodiment of the present disclosure. As illustrated, a processor (for example, the processor 2220 of FIG. 22) may generate visual descriptors associated respectively with the plurality of candidate feature points 2612, 2614, 2616, 2618 extracted based on the image 2600.

Specifically, by using the visual descriptor generation model, the processor may generate a plurality of visual descriptors for regions having a predetermined size within the image 2600 centered respectively on the coordinate values of the candidate feature points 2612, 2614, 2616, 2618. For example, as illustrated, the processor may generate a first visual descriptor for a first region 2622 within the image 2600 centered on the coordinate value of the first candidate feature point 2612, may generate a second visual descriptor for a second region 2624 centered on the coordinate value of the second candidate feature point 2614, and may likewise generate a third visual descriptor for a third region 2626 centered on the coordinate value of the third candidate feature point 2616 and a fourth visual descriptor for a fourth region 2628 centered on the coordinate value of the fourth candidate feature point 2618.

In an embodiment, the visual descriptor generation model may include a plurality of sub-models. Each of the plurality of sub-models may be a multi-head model configured to extract visual descriptors for regions having different sizes for at least a partial region of an input image. For example, the visual descriptor generation model may include a sub-model for generating visual descriptors for a 16×16-pixel region, a sub-model for generating visual descriptors for a 32×32-pixel region, and/or a sub-model for generating visual descriptors for a 48×48-pixel region; however, the model is not limited thereto.

FIG. 27 is a diagram illustrating, by way of example, feature-point matching between a first image 2710 and a second image 2720 in which a specific cardiovascular structure is captured according to an embodiment of the present disclosure. As illustrated, the processor (for example, the processor 2220 of FIG. 22) performs feature-point matching between a first set of candidate feature points 2712, 2716, 2718 of the first image 2710 and a second set of candidate feature points 2722, 2726, 2728 of the second image 2720, thereby obtaining CIP matching pairs.

In an embodiment, by using a matching model, the processor may generate a plurality of embedding vectors based on the first set of candidate feature points 2712, 2716, 2718 and the first set of visual descriptors of the first image 2710 and the second set of candidate feature points 2722, 2726, 2728 and the second set of visual descriptors of the second image 2720. The first set of embedding vectors refers to embedding vectors generated using visual descriptors associated with each of the candidate feature points of the first set of the first image 2710. Similarly, the second set of embedding vectors refers to embedding vectors generated using visual descriptors associated with each of the candidate feature points of the second set of the second image 2720.

Specifically, among the first set of candidate feature points 2712, 2716, 2718, the processor may identify a first candidate feature point, may identify a first visual descriptor corresponding to the first candidate feature point among the first set of visual descriptors, and may generate a first embedding vector based on the coordinate value of the first candidate feature point and the first visual descriptor. Likewise, among the second set of candidate feature points 2722, 2726, 2728, the processor may identify a second candidate feature point, may identify a second visual descriptor corresponding to the second candidate feature point among the second set of visual descriptors, and may generate a second embedding vector based on the coordinate value of the second candidate feature point and the second visual descriptor.

In an embodiment, by using the matching model, the processor may generate a plurality of embedding vectors based on the first image 2710 with its first set of candidate feature points 2712, 2716, 2718, the first set of visual descriptors, first camera meta-information, the second image 2720 with its second set of candidate feature points 2722, 2726, 2728, the second set of visual descriptors, and second camera meta-information. Here, the camera meta-information may include at least one of a rotation matrix, a translation matrix, or a focal length associated respectively with each image. In an embodiment, the camera meta-information may be information associated with the Digital Imaging and Communications in Medicine (DICOM) standard.

Then, by using the matching model, the processor may perform feature point matching based on the first set of embedding vectors associated with the first image 2710 and the second set of embedding vectors associated with the second image 2720. For example, by using the matching model, the processor may generate a score matrix based on similarity scores calculated among respective embedding vectors included in the first and second sets of embedding vectors and may determine CIP matching pairs. As illustrated, the candidate feature point 2712 of the first image 2710 may be matched with the candidate feature point 2722 of the second image 2720, and likewise the candidate feature points 2716, 2718 of the first image 2710 may be matched respectively with the candidate feature points 2726, 2728 of the second image 2720.

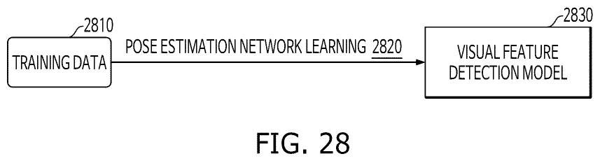

FIG. 28 is a diagram illustrating a learning method for a visual feature detection model 2830 according to an embodiment of the present disclosure. In an embodiment, the visual feature detection model 2830 may be trained or updated through pose estimation network learning 2820 based on training data 2810; that is, the visual feature detection model 2830 may be a pose estimation-network-based model. For example, the visual feature detection model 2830 may be a pose estimation-network-based model trained based on training data 2810 to detect feature points in an input image. Here, the training data 2810 may include an image in which a cardiovascular structure is captured. Specifically, a processor (for example, the processor 2220 of FIG. 22) may train, through pose estimation network learning 2820 based on the training data 2810 including an image in which a cardiovascular structure is captured, the visual feature detection model 2830 for extracting candidate feature points (for example, candidate branching points) included in the image in which a cardiovascular structure is captured.

Pose estimation network learning 2820 for the visual feature detection model 2830 for detecting feature points within an image can be performed in various ways. For example, the pose estimation network learning 2820 may train the model to minimize a loss function by using training data 2810 including feature point data extracted by using an initial model of the visual feature detection model 2830 (for example, extracted candidate branching points) and ground truth data (for example, labeled branching points) so that branching points that are feature points in an input image are detected; however, the learning method is not limited to this and may be implemented in various ways known in the art.

According to an embodiment, input variables for the visual feature detection model 2830 may include information regarding an image capturing a specific cardiovascular structure, and output variables for the visual feature detection model 2830 may include information regarding candidate feature points within an image capturing a specific cardiovascular structure.

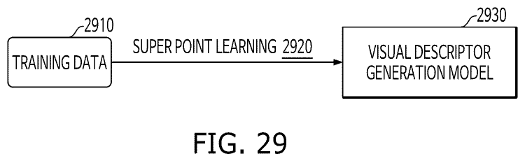

FIG. 29 is a diagram illustrating a learning method for a visual descriptor generation model 2930 according to an embodiment of the present disclosure. In an embodiment, the visual descriptor generation model 2930 may be generated or updated through super point learning 2920 based on training data 2910; that is, the visual descriptor generation model 2930 may be a super point-network-based model. For example, the visual descriptor generation model 2930 may be a super point-network-based model trained based on training data 2910 to generate visual descriptors for at least a partial region of an input image. Here, the training data 2910 may include an image in which a cardiovascular structure is captured. In an embodiment, the training data 2910 may be image or data corresponding to a partial region associated with candidate feature points (for example, candidate branching points) in an image in which a cardiovascular structure is captured. For example, the training data 2910 may include a training patch image associated with an image in which a cardiovascular structure is captured. Specifically, a processor (for example, the processor 2220 of FIG. 22) may train, through the super point learning method 2920 based on the training data 2910, the visual descriptor generation model 2930 for generating a visual descriptor for a region corresponding to a predetermined size centered on a candidate feature point (for example, a candidate branching point) in an image in which a cardiovascular structure is captured.

Super point learning 2920 for the visual descriptor generation model 2930 that generates a visual descriptor for at least a partial region of an image can be performed in various ways. For example, the super point learning 2920 may train the model to generate a visual descriptor for a region corresponding to a predetermined size centered on a candidate feature point (for example, a candidate branching point) in an image in which a cardiovascular structure is captured by updating weights using results calculated from a loss function based on the training data 2910; however, the learning method is not limited to this and may be implemented in various ways known in the art.

In an embodiment, input variables for the visual descriptor generation model 2930 may include an image capturing a specific cardiovascular structure and/or image or data corresponding to a partial region associated with candidate feature points in an image in which a cardiovascular structure is captured, and output variables for the visual descriptor generation model 2930 may include information regarding visual descriptors associated with the candidate feature points.

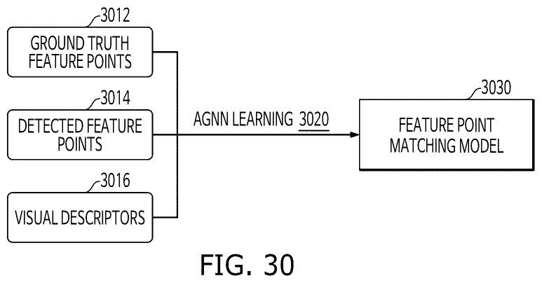

FIG. 30 is a diagram illustrating a learning method for a feature point matching model 3030 according to an embodiment of the present disclosure. In an embodiment, the feature point matching model 3030 may be generated through AGNN (attention-based graph neural network) learning 3020 based on training-data sets 3012, 3014, 3016; that is, the feature point matching model 3030 may be an AGNN-based model. For example, the feature point matching model 3030 may be an AGNN-based model trained to match candidate branching points among input images. Here, the training-data sets 3012, 3014, 3016 may include 3012 associated with images in which a cardiovascular structure is captured, detected feature points 3014, and visual descriptors 3016. The ground truth feature points 3012 may include matched candidate branching points among different images in which a cardiovascular structure is captured, the detected feature points 3014 may include candidate branching points extracted by using a visual feature detection model (for example, the model 2830 of FIG. 28), and the visual descriptors 3016 may include visual descriptors for candidate branching points generated by using a visual descriptor generation model (for example, the model 2930 of FIG. 29). Specifically, a processor (for example, the processor 2220 of FIG. 22) may train, through the AGNN learning 3020 based on the training-data sets 3012, 3014, 3016, the feature point matching model 3030 for matching feature points (for example, candidate branching points) among images in which a cardiovascular structure is captured.

The AGNN learning 3020 for the feature point matching model 3030 that matches candidate branching points among images can be performed in various ways. For example, the AGNN learning 3020 may train the model to match candidate branching points among input images by minimizing a loss function using the training-data sets 3012, 3014, 3016 including ground truth feature points 3012, detected feature points 3014, and visual descriptors 3016 associated with images in which a cardiovascular structure is captured; however, the learning method is not limited to this and may be implemented in various ways known in the art.

In an embodiment, input variables for the feature point matching model 3030 may include candidate feature points associated with an image capturing a specific cardiovascular structure and visual descriptor data associated therewith, and output variables for the feature point matching model 3030 may include data for matching pairs among the candidate feature points.

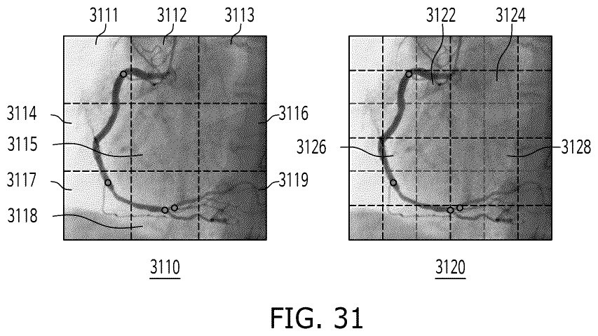

FIG. 31 is a diagram illustrating, by way of example, a method of performing feature point matching between images capturing a specific cardiovascular structure according to another embodiment of the present disclosure. As illustrated, a processor (for example, the processor 2220 of FIG. 22) may extract a plurality of patch images 3111, 3112, 3113, 3114, 3115, 3116, 3117, 3118, 3119, 3122, 3124, 3126, 3128 from an image capturing a specific cardiovascular structure in order to perform feature point matching between that image and another image capturing the same cardiovascular structure. By using the plurality of patch images 3111-3119 extracted from the first example 3110 and the plurality of patch images 3122-3128 extracted from the second example 3120, along with the plurality of patch images extracted from another image capturing the specific cardiovascular structure, the processor may perform feature-point matching to determine CIP matching pairs.

The first example 3110 illustrates an example in which a first set of patch images 3111-3119 is extracted based on an image capturing a specific cardiovascular structure. In an embodiment, the processor may extract the first set of patch images 3111-3119 by using a first grid based on the image capturing the specific cardiovascular structure. Here, an interval of the first grid may be predetermined. For example, as illustrated, the processor may extract the first set of nine patch images 3111-3119 from the image capturing the specific cardiovascular structure by using a first grid divided into thirds.

The second example 3120 illustrates an example in which a second set of patch images 3122-3128 is extracted by using a second grid. In an embodiment, the processor may generate the second grid so that intersections of the first grid serve as centers of the second grid. Then, the processor may extract the second set of patch images including a total of four patch images 3122-3128 from the image capturing the specific cardiovascular structure by using the second grid. For example, as illustrated, the processor may extract the second set of four patch images 3122-3128 from the image capturing the specific cardiovascular structure by using the second grid.

In an embodiment, the processor may determine similar patch image pairs by comparing each of the plurality of patch images 3111-3119, 3122-3128 extracted from the image capturing the specific cardiovascular structure with each of a plurality of patch images extracted from another image capturing the specific cardiovascular structure. Then, the processor may perform matching among one or more feature points included in the patch image pair and may obtain coordinate values for the matched points on the image capturing the specific cardiovascular structure. Based on the coordinate values of the feature points obtained in this way, CIP matching pairs between different images capturing the specific cardiovascular structure may be determined.

The above flowchart and description are merely exemplary; in some embodiments, the steps may be implemented differently. For example, in some embodiments, the order of the steps may be changed, some steps may be repeated, some steps may be omitted, or additional steps may be included.

The above-described methods may be provided as a computer program stored on a computer-readable recording medium for execution on a computer. A medium may continuously store computer-executable programs or may store them temporarily for execution or download. The medium may be any recording medium or recording medium in a single or combined hardware form, not limited to a medium directly connected to a computer system, and may exist distributed over a network. Examples of the medium include magnetic media such as hard disks, floppy disks, and magnetic tapes; optical-recording media such as CD-ROMs and DVDs; magneto-optical media such as floptical disks; and processor-readable media of various types such as ROM, RAM, flash memory, registers, and magnetic or optical data storage devices. Other examples of media include recording media or storage media managed by an app store that distributes applications or by various sites or servers that supply or distribute software.

The methods, operations, or techniques of the present disclosure may be implemented by various means. For example, the techniques may be implemented by hardware, firmware, software, or a combination thereof. Those skilled in the art will understand that the various illustrative logical blocks, modules, circuits, and algorithm steps described in connection with the disclosure can be embodied as electronic hardware, computer software, or combinations thereof. To clearly illustrate this interchangeability, various illustrative components, blocks, modules, circuits, and steps have been described above generally in terms of their functionality. Whether the functionality is implemented as hardware or software depends upon the particular application and design constraints imposed on the overall system. Implementations described as hardware may be substituted by corresponding software implementations and vice versa, without departing from the scope of the disclosure.

In a hardware implementation, processing units used to perform the techniques may be implemented within one or more ASICs, DSPs, digital-signal-processing devices, programmable logic devices, field-programmable gate arrays, processors, controllers, microcontrollers, microprocessors, electronic devices, other electronic units designed to perform the functions described herein, computers, or combinations thereof.

Thus, various illustrative logical blocks, modules, and circuits described in connection with the disclosure may be implemented or performed within a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, for example, a combination of a DSP and a microprocessor, multiple microprocessors, one or more microprocessors in conjunction with a DSP core, or any other such configuration.

In a firmware or software implementation, the techniques may be implemented with modules (e.g., procedures, functions, etc.) that perform the functions described herein. Any machine-readable medium tangibly embodying program instructions may be used for implementing the techniques described herein. For example, software codes can be stored in a memory and executed by a processor. Memory may be implemented within the processor or external to the processor, in which case it can be communicatively coupled to the processor via various means as is known in the art.

When implemented in software, the techniques described above may be stored on or transmitted over a computer-readable medium as one or more instructions or code. Computer-readable media include both computer-storage media and communication media that facilitate transfer of a computer program from one place to another. Storage media may be any available media that can be accessed by a computer. By way of example, and not limitation, computer-readable media can comprise RAM, ROM, EEPROM, CD-ROM or other optical-disk storage, magnetic-disk storage or other magnetic storage devices, or any other medium that can be used to carry or store desired program code in the form of instructions or data structures and that can be accessed by a computer. Also, any connection is properly termed a computer-readable medium.

For example, if the software is transmitted from a website, server, or other remote source over coaxial cable, fiber-optic cable, twisted-pair, digital-subscriber-line (DSL), or wireless technologies such as infrared, radio, and microwave, then coaxial cable, fiber-optic cable, twisted-pair, DSL, or infrared, radio, and microwave are included in the definition of a medium. As used herein, disks and discs include compact discs (CDs), laser discs, optical discs, digital versatile discs (DVDs), floppy disks, and Blu-ray discs, wherein disks reproduce data magnetically and discs reproduce data optically with lasers. Combinations of the above are also included within the scope of computer-readable media.

Software modules may reside in RAM memory, flash memory, ROM memory, NVRAM, PROM, EPROM, EEPROM, registers, hard disks, removable disks, CD-ROMs, or any other form of recording medium known in the art. An exemplary recording medium may be coupled to a processor such that the processor can read information from, and write information to, the recording medium. Alternatively, the recording medium may be integral to the processor. The processor and the recording medium may reside in an ASIC, which may be part of a user terminal. Alternatively, the processor and the recording medium may reside as distinct components in a user terminal.

Although the embodiments described above have been described in the context of standalone computer systems utilizing aspects of the disclosed subject matter, the disclosure is not so limited, and may be implemented in any computing environment, such as a network or distributed computing environment. Furthermore, aspects of the subject matter described herein may be implemented on multiple processing chips or devices, and storage may similarly be affected across multiple devices. Such devices may include PCs, network servers, and portable devices.

While the disclosure has been described with reference to certain embodiments, various modifications and changes may be made without departing from the scope of the disclosure as is apparent to those skilled in the art. Such modifications and changes are intended to fall within the scope of the appended claims.

What is claimed is:

1. A correspondence point matching method performed by an apparatus comprising at least one processor, the correspondence point matching method comprising:
obtaining a first training patch image and a second training patch image associated with the first training patch image; and
training a machine learning model, based on the obtained first and second training patch images, so that a first feature point associated with the first training patch image corresponds to a second feature point associated with the second training patch image,
wherein the machine learning model is trained to determine, as an allowable movement range for a feature point, a second range different from a first range associated with at least one of the first training patch image or the second training patch image, and to move at least one of the first feature point or the second feature point to a target point within the determined second range.

2. The correspondence point matching method as claimed in claim 1, wherein the second range is wider than the first range and is determined based on an area occupied by the first training patch image in a medical image.

3. The correspondence point matching method as claimed in claim 1, wherein obtaining the second training patch image comprises:
obtaining, from a medical image, the second training patch image having a size associated with the second range,
wherein the second training patch image having the size associated with the second range and the first training patch image are input to the machine learning model.

4. The correspondence point matching method as claimed in claim 1, wherein the machine learning model is trained to move the first feature point initially determined from the first training patch image to a first target point, and to move the second feature point initially determined from the second training patch image to a second target point.

5. The correspondence point matching method as claimed in claim 4, wherein the initially determined first feature point is a center of the first training patch image and the initially determined second feature point is a center of the second training patch image.

6. The correspondence point matching method as claimed in claim 1, wherein training the machine learning model comprises:
inputting the first and second training patch images to the machine learning model and training the machine learning model so that the second feature point is moved to a second target point; and
inputting the second training patch image, in which the second feature point has been moved, and the first training patch image to the machine learning model and training the machine learning model so that the first feature point is moved to a first target point.

7. The correspondence point matching method as claimed in claim 1, wherein, based on a determination by the machine learning model that the target point is located within the second range, the machine learning model is trained to associate the first feature point with the second feature point.

8. The correspondence point matching method as claimed in claim 1, further comprising:
receiving a plurality of images in which a cardiovascular structure is captured;
obtaining vascular information associated with each of the plurality of images;
generating, based on the vascular information, a plurality of feature vectors corresponding respectively to the plurality of images; and
using the machine learning model to associate at least one point of each of the plurality of images with a corresponding point of another one of the plurality of images, based on the plurality of feature vectors,
wherein each of the plurality of images is different from each other.

9. The correspondence point matching method as claimed in claim 8,
wherein obtaining the vascular information comprises:
identifying a first image and a second image among the plurality of images;
obtaining first center-line information corresponding to a center-line of at least a portion of blood vessels included in the first image; and
obtaining second center-line information corresponding to a center-line of at least a portion of blood vessels included in the second image, and
wherein generating the plurality of feature vectors comprises:
generating a first set of patch images based on the first center-line information; and
generating a second set of patch images based on the second center-line information.

10. The correspondence point matching method as claimed in claim 9, wherein generating the plurality of feature vectors comprises:
generating a first set of positional embedding vectors corresponding respectively to the first set of patch images;
generating a second set of positional embedding vectors corresponding respectively to the second set of patch images;
generating a first feature vector, using a transformer model, based on the first set of positional embedding vectors; and
generating a second feature vector, using the transformer model, based on the second set of positional embedding vectors.

11. The correspondence point matching method as claimed in claim 8, wherein using the machine learning model to associate the at least one point of each of the plurality of images with the corresponding point of another one of the plurality of images comprises:
generating a score matrix by determining correlation coefficients among the plurality of feature vectors; and
determining, based on the generated score matrix, at least one point in each of the plurality of images as a correspondence point.

12. The correspondence point matching method as claimed in claim 1, wherein training the machine learning model comprises:
receiving camera meta information associated with the first and second training patch images; and
inputting the camera meta information to the machine learning model.

13. A correspondence point matching method performed by an apparatus comprising at least one processor, the correspondence point matching method comprising:
obtaining a first training patch image and a second training patch image associated with the first training patch image; and
training a machine learning model, based on the obtained first and second training patch images, so that a first feature point associated with the first training patch image corresponds to a second feature point associated with the second training patch image,
wherein the machine learning model is trained to move the first feature point to a first target point and to move the second feature point to a second target point.

14. The correspondence point matching method as claimed in claim 13, wherein the machine learning model is trained to determine, as a movable range for a feature point, a second range wider than a first range associated with at least one of the first training patch image and the second training patch image, and to move the first feature point to the first target point within the second range.

15. A non-transitory computer-readable recording medium storing a computer program for executing the method according to claim 1 on a computer.

16. An information processing system comprising:
a memory; and
at least one processor connected to the memory and configured to execute at least one computer-readable program stored in the memory,
wherein the at least one computer-readable program includes instructions that are configured to cause the information processing system to:
obtain a first training patch image and a second training patch image associated with the first training patch image; and
train a machine learning model, based on the obtained first and second training patch images, so that a first feature point associated with the first training patch image corresponds to a second feature point associated with the second training patch image, and
wherein the machine learning model is trained to determine, as an allowable movement range for a feature point, a second range different from a first range associated with at least one of the first training patch image or the second training patch image, and move at least one of the first feature point or the second feature point to a target point within the second range.
